(19) United States
(12) Patent Application Publication
(10) Pub. No.: US 2026/0204551 A1
(43) Pub. Date: Jul. 16, 2026

(54) ELECTRODE COMPOSITION, METHOD FOR PRODUCING ELECTRODE COMPOSITION, METHOD FOR PRODUCING ELECTRODE SHEET, AND METHOD FOR PRODUCING BATTERY

(71) Applicant: Panasonic Intellectual Property Management Co., Ltd., Osaka (JP)

(72) Inventors: TATSUYA OSHIMA, Osaka (JP); KAZUYA HASHIMOTO, Osaka (JP)

(21) Appl. No.: 19/564,079

(22) Filed: Mar. 11, 2026

Related U.S. Application Data
(63) Continuation of application No. PCT/JP2024/022831, filed on Jun. 24, 2024.

(30) Foreign Application Priority Data
Oct. 6, 2023 (JP) 2023-174727

(51) Int. Cl. H01M 4/36; H01M 4/04; H01M 4/1391; H01M 4/525; H01M 4/62; H01M 10/0525; H01M 10/0562

(52) U.S. Cl. CPC H01M 4/366; H01M 4/0404; H01M 4/0407; H01M 4/1391; H01M 4/525; H01M 4/622; H01M 10/0525; H01M 10/0562; H01M 2300/008

(57) ABSTRACT

An electrode composition contains a solvent, a coated active material dispersed in the solvent, and a binder dispersed in the solvent, wherein the coated active material includes an active material and a coating layer covering at least part of a surface of the active material, the coating layer contains a first solid electrolyte, the first solid electrolyte contains at least one selected from the group consisting of a sulfide solid electrolyte and a halide solid electrolyte, the binder contains a styrene elastomer, and the styrene elastomer has a total nitrogen content of 30 ppm or more and 300 ppm or less.

### BACKGROUND

### 1. Technical Field

The present disclosure relates to an electrode composition, a method for producing an electrode composition, a method for producing an electrode sheet, and a method for producing a battery.

### 2. Description of the Related Art

International Publication No. WO 2012/073678 describes an electrode composition containing an active material and a modified styrene elastomer.

### SUMMARY

In the production of an electrode, a technique for improving the flowability of an electrode composition is desired.

One non-limiting and exemplary embodiment provides an electrode composition having improved flowability.

In one general aspect, the techniques disclosed here feature an electrode composition contains a solvent, a coated active material dispersed in the solvent, and a binder dispersed in the solvent, wherein the coated active material includes an active material and a coating layer covering at least part of a surface of the active material, the coating layer contains a first solid electrolyte, the first solid electrolyte contains at least one selected from the group consisting of a sulfide solid electrolyte and a halide solid electrolyte, the binder contains a styrene elastomer, and the styrene elastomer has a total nitrogen content of 30 ppm or more and 300 ppm or less.

The present disclosure can provide an electrode composition having improved flowability.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view of an electrode composition according to a first embodiment;

FIG. 2 is a graph for explaining a method for evaluating the flowability of an electrode composition;

FIG. 3 is a schematic view of an electrode composition according to a modified example of the first embodiment;

FIG. 4 is a flow chart of a method for producing an electrode sheet in a second embodiment;

FIG. 5 is a cross-sectional view of an electrode according to the second embodiment;

FIG. 6 is a cross-sectional view of an electrode according to the second embodiment;

FIG. 7 is a cross-sectional view of a battery precursor according to the second embodiment;

FIG. 8 is a cross-sectional view of a battery according to a third embodiment;

FIG. 9 is a graph obtained by plotting the viscosity obtained in the evaluation of the flowability of an electrode composition versus shear rate in examples and comparative examples; and

FIG. 10 is a graph obtained by plotting the viscosity obtained in the evaluation of the flowability of an electrode composition versus shear rate in examples and comparative examples.

### DETAILED DESCRIPTIONS

### (Underlying Knowledge Forming Basis of the Present Disclosure)

To produce a battery, such as a nonaqueous electrolyte secondary battery or a solid-state secondary battery, it is necessary to prepare an electrode composition containing an active material, a solvent, and a binder and having flowability. For example, an electrode composition having flowability can be used to form an electrode sheet by applying the electrode composition to the surface of a current collector or the like. In the production of an electrode sheet, an electrode composition can be used for production by wet application (wet coating). The wet application has higher coating film uniformity and mass productivity than dry application (dry coating).

An active material and/or a solid electrolyte are sensitive to the polarity of a solvent and the polarity of a binder. To produce an electrode composition that is less likely to cause a decrease in output characteristics and a decrease in cycle performance of a battery, it is necessary to use a solvent having a relatively low polarity and a binder having a relatively low polarity. A solvent having a low polarity is, for example, an aromatic hydrocarbon. A binder having a low polarity is, for example, a styrene elastomer. However, when a solvent having a low polarity and an elastomer having a low polarity are used, the interaction between active material particles acts more strongly. More specifically, when a solvent having a low polarity and an elastomer having a low polarity are used, the flowability of the electrode composition may decrease. Thus, to produce an electrode sheet using a solvent having a low polarity and a binder having a low polarity, a technique for improving the flowability of the electrode composition is required.

The present inventors have studied an electrode composition that contains an active material and a binder containing an elastomer. As a result, the present inventors have found that the flowability is improved by coating an active material with a halide solid electrolyte or a sulfide solid electrolyte and including a styrene elastomer having a total nitrogen content of 30 ppm or more and 300 ppm or less, which moderately interacts with the solid electrolyte. More specifically, polarity can be imparted to a styrene elastomer composed mainly of carbon (C) and hydrogen (H) by introducing a modifying group that is a functional group containing nitrogen (N), such as an amino group, into the styrene elastomer. It is considered that this causes adsorption due to the interaction between the N atom(s) contained in the styrene elastomer and the halide solid electrolyte or the sulfide solid electrolyte covering the active material, can improve the affinity between the coated active material and a solvent, and can improve the flowability of the electrode composition. From the above perspective, the configuration of the present disclosure has been conceived.

In an electrode composition that contains a binder containing a styrene elastomer having a total nitrogen content of less than 30 ppm and an active material, the active material in the electrode composition has lower dispersibility. This problem is considered to be caused by insufficient adsorption of the styrene elastomer to the active material. More specifically, the styrene elastomer having a total nitrogen content of less than 30 ppm has an insufficient interaction with the active material, which is considered to cause the above problem.

Embodiments of the present disclosure will be described below with reference to the accompanying drawings. The present disclosure is not limited to the following embodiments.

### First Embodiment

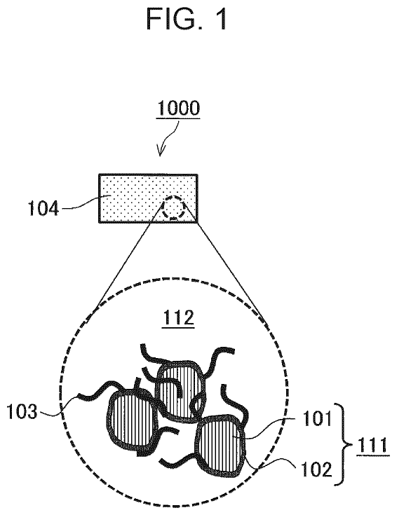

FIG. 1 is a schematic view of an electrode composition 1000 according to a first embodiment. The electrode composition 1000 contains an ionic conductor 112 and a solvent 104. The ionic conductor 112 contains a coated active material 111 and a binder 103. The coated active material 111 contains an active material 101 and a coating layer 102 covering at least part of the surface of the active material 101. The coating layer 102 contains a first solid electrolyte. The first solid electrolyte contains at least one selected from the group consisting of a halide solid electrolyte and a sulfide solid electrolyte. The ionic conductor 112 is dispersed or dissolved in the solvent 104. More specifically, the coated active material 111 and the binder 103 are dispersed in the solvent 104. The binder 103 may be partially or completely dissolved in the solvent 104. The binder 103 contains a styrene elastomer. The styrene elastomer has a total nitrogen content of 30 ppm or more and 300 ppm or less.

The above configuration can improve the flowability of the electrode composition 1000. A homogeneous electrode sheet with a uniform thickness can be produced by using the electrode composition 1000. The homogeneous electrode sheet with a uniform thickness can improve the energy density of the battery. The battery may be a liquid battery containing an electrolyte solution or a solid-state battery not containing an electrolyte solution.

Control of the total nitrogen content of the styrene elastomer, more specifically, the use of a styrene elastomer having a total nitrogen content of 30 ppm or more and 300 ppm or less, can suppress a phenomenon in which the dispersibility of the coated active material 111 is impaired. Since the first solid electrolyte in the coating layer 102 is a ceramic material sensitive to the polarity of the styrene elastomer constituting the binder 103, it is required to appropriately control the total nitrogen content of the styrene elastomer, specifically, on the order of ppm. As described above, in the electrode composition 1000, the styrene elastomer constituting the binder 103 has a total nitrogen content of 30 ppm or more and 300 ppm or less. This can improve the dispersibility of the coated active material 111 in the electrode composition 1000 and improve the flowability of the electrode composition.

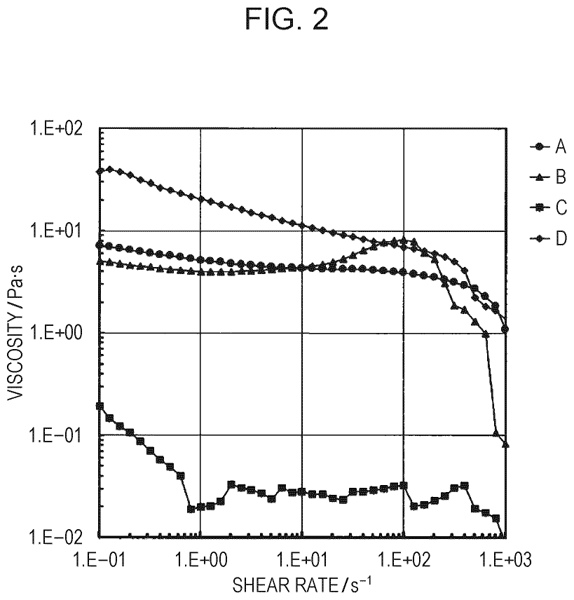

The flowability of the electrode composition 1000 can be evaluated by the shape of a flow curve obtained using a viscosity/viscoelasticity measuring instrument in a speed control mode. FIG. 2 is a graph for explaining a method for evaluating the flowability of the electrode composition 1000. In FIG. 2, the vertical axis represents the viscosity of the electrode composition, and the horizontal axis represents the shear rate. The flowability of the electrode composition 1000 can be evaluated by the following method. First, the viscosity of the electrode composition is measured using the viscosity/viscoelasticity measuring instrument under the conditions of 25° C. and the speed control mode and at a shear rate in the range of 0.1/s to 1000/s, and the measurement results are plotted on the graph described above. In this graph, when a behavior is obtained in which the viscosity of the electrode composition continuously decreases as the shear rate increases (plot A in FIG. 2), the electrode composition can be evaluated as having high flowability. On the other hand, when a phenomenon in which the viscosity increases as the shear rate increases, so-called dilatancy behavior, is obtained as in plot B in FIG. 2, the electrode composition can be evaluated as having poor flowability. When a behavior is obtained in which the viscosity changes discontinuously as the shear rate increases as in plot C in FIG. 2, the electrode composition can be evaluated as having poor flowability. When a behavior is obtained in which the viscosity decreases rapidly as the shear rate increases as in plot D in FIG. 2, the electrode composition can be evaluated as having poor flowability.

The electrode composition 1000 may be a slurry having flowability. When the electrode composition 1000 has flowability, an electrode sheet can be formed by a wet method, such as a coating method. The “electrode sheet” may be a free-standing sheet member or may be a positive electrode layer or a negative electrode layer supported by a current collector, a substrate, or an electrode assembly.

The electrode composition 1000 will be described in detail below.

### [Electrode Composition]

The electrode composition 1000 contains the ionic conductor 112 and the solvent 104. The ionic conductor 112 contains the coated active material 111 and the binder 103. The coated active material 111 contains the active material 101 and the coating layer 102 covering at least part of the active material 101. The coating layer 102 contains a first solid electrolyte. The active material 101, the coating layer 102, the binder 103, the coated active material 111, the ionic conductor 112, and the solvent 104 will be described in detail below.

### <Active Material>

The active material 101 in the first embodiment contains a material having characteristics of storing and releasing metal ions (for example, lithium ions). The active material 101 includes, for example, a positive-electrode active material or a negative-electrode active material. When the electrode composition 1000 contains the active material 101, an electrode sheet produced from the electrode composition 1000 can be used to produce a lithium secondary battery.

The active material 101 includes, for example, a material having characteristics of storing and releasing metal ions (for example, lithium ions) as a positive-electrode active material. The positive-electrode active material may be a transition metal oxide, a transition metal fluoride, a polyanionic material, a fluorinated polyanionic material, a transition metal sulfide, a transition metal oxysulfide, a transition metal oxynitride, a lithium-containing compound thereof, or the like. The lithium-containing transition metal oxide may be Li(NiCoAl)O₂(NCA), Li(NiCoMn)O₂(NCM), LiCoO₂, or the like. For example, the use of a lithium-containing transition metal oxide as the positive-electrode active material can reduce the production cost of the electrode composition 1000 and improve the average discharge voltage of the battery. Li(NiCoAl)O₂ means that Ni, Co, and Al are contained at an arbitrary ratio. Li(NiCoMn)O₂ means that Ni, Co, and Mn are contained at an arbitrary ratio.

The positive-electrode active material may have a median diameter of 0.1 μm or more and 100 μm or less, or 1 μm or more and 10 μm or less. When the positive-electrode active material has a median diameter of 0.1 μm or more, the active material 101 can be easily dispersed in the solvent 104 in the electrode composition 1000. This improves the charge-discharge characteristics of a battery including an electrode sheet produced from the electrode composition 1000. When the positive-electrode active material has a median diameter of 100 μm or less, the lithium diffusion rate in the positive-electrode active material is improved. Thus, the battery can operate at high output power.

The median diameter refers to the particle size at which the cumulative volume in the volumetric particle size distribution is equal to 50%. The volumetric particle size distribution is determined by a laser diffraction scattering method. The same applies to other materials described below.

The active material 101 includes, for example, a material having characteristics of storing and releasing metal ions (for example, lithium ions) as a negative-electrode active material. The negative-electrode active material may be a metallic material, a carbon material, an oxide, a nitride, a tin compound, a silicon compound, a lithium-containing compound thereof, or the like. The metallic material may be a single metal or an alloy. The metallic material may be a lithium metal, a lithium alloy, or the like. The carbon material may be natural graphite, coke, graphitizing carbon, carbon fiber, spherical carbon, artificial graphite, amorphous carbon, or the like. The use of silicon (Si), tin (Sn), a silicon compound, a tin compound, or the like can improve the capacity density of the battery. The use of a lithium-containing oxide containing titanium (Ti) or niobium (Nb) can improve the safety of the battery.

The negative-electrode active material may have a median diameter of 0.1 μm or more and 100 μm or less. When the negative-electrode active material has a median diameter of 0.1 μm or more, the negative-electrode active material and a solid electrolyte in a negative electrode 303 can be well dispersed. This improves the charge-discharge characteristics of the battery. When the negative-electrode active material has a median diameter of 100 μm or less, the lithium diffusion rate in the negative-electrode active material is improved. Thus, the battery can operate at high output power.

### <Coating Layer>

The coating layer 102 may uniformly cover the active material 101.

The coating layer 102 may cover only part of the surface of the active material 101. Since particles of the active material 101 are in direct contact with each other through a portion that is not covered with the coating layer 102, electronic conductivity between the particles of the active material 101 is improved. Thus, the battery can operate at high output power.

A portion of the coating layer 102 may have a particle-like structure including a plurality of particles. The particles may have a diameter of 3 μm or less, 1 μm or less, or 500 nm or less. Particles with a diameter of 3 μm or less are particles of a first solid electrolyte that is a coating material. When the coating layer 102 has a fine particle-like structure, deformation of the coating layer 102 is promoted during the production of a battery, so that a favorable interface can be formed between the coated active material 111 and another material. The lower limit of the diameters of the particles is, for example, but not limited to, 5 nm.

The term “diameter of a particle”, as used herein, refers to the diameter of a spherical particle corresponding to the volume of the particle. Thus, the expression “the diameter of a particle” does not necessarily mean that the particle is spherical. The diameter of a particle is determined by a laser diffraction scattering method. The same applies to other materials described below.

The particle-like structure refers to a structure in which a plurality of particles with a diameter of 3 μm or less are linked together and randomly arranged. Each of the plurality of particles constituting the particle-like structure may have a diameter of 3 μm or less. The lower limit of the diameters of the particles is, for example, but not limited to, 5 nm or more.

The particle-like structure including a plurality of particles with a diameter of 3 μm or less can be formed by using particles with a sufficiently small diameter as a coating material and appropriately adjusting the energy applied by the processing apparatus when forming the coating layer 102.

The mass of the coating layer 102 may be 4.5% or less of the mass of the coated active material 111. When the mass of the coating layer 102 is 4.5% or less of the mass of the coated active material 111, the resistance of the battery can be further reduced. The lower limit of the mass of the coating layer 102 is, for example, but not limited to, 0.1% of the mass of the coated active material 111.

The coating layer 102 contains a first solid electrolyte. The first solid electrolyte has ionic conductivity. The ionic conductivity is, typically, lithium ion conductivity. The coating layer 102 may contain the first solid electrolyte as a main component or may contain only the first solid electrolyte. The term “main component” refers to a component contained in the largest amount in terms of mass ratio. The phrase “contain only the first solid electrolyte” means that a material other than the first solid electrolyte is not intentionally added except for incidental impurities. For example, the raw materials of the first solid electrolyte, by-products generated when the first solid electrolyte is produced, and the like are included in the incidental impurities. The ratio of the mass of the incidental impurities to the mass of the entire coating layer 102 may be 5% or less, 3% or less, 1% or less, or 0.5% or less.

The particles of the coating material used to form the coating layer 102 may have a median diameter of 3 μm or less. When the particles of the coating material has a median diameter of 3 μm or less, the particles of the coating material can be uniformly distributed on the surface of the active material 101. Furthermore, mechanical energy is applied to the active material 101 and the particles of the coating material, and voids in the coating layer 102 are crushed, so that a thin and uniform coating layer 102 can be formed. It may be 1 μm or less, 500 nm or less, 100 nm or less, or 60 nm or less. The lower limit of the median diameter of the particles of the coating material is, for example, but not limited to, 1 nm.

The particles of the coating material used to form the coating layer 102 may be particles of the first solid electrolyte.

In the present specification, the “particle” may be an aggregate of particles or may be a particle composed of a single particle. That is, the particle may be a secondary particle or a primary particle.

The particles of the coating material used to form the coating layer 102 may have a specific surface area of 10 m²/g or more, 20 m²/g or more, or 40 m²/g or more. When the particles of the coating material have a large specific surface area, the particles can uniformly adhere to the surface of the active material 101. Consequently, a uniform coating layer 102 can be formed. The upper limit of the specific surface area of the particles of the coating material is, for example, but not limited to, 100 m²/g.

The first solid electrolyte in the coating layer 102 includes a halide solid electrolyte or a sulfide solid electrolyte. The first solid electrolyte in the coating layer 102 may be a halide solid electrolyte. The first solid electrolyte in the coating layer 102 may be a sulfide solid electrolyte.

The term “halide solid electrolyte”, as used herein, refers to a solid electrolyte containing a halogen element and no sulfur. The term “solid electrolyte containing no sulfur”, as used herein, refers to a solid electrolyte represented by a composition formula containing no sulfur element. Thus, a solid electrolyte containing a very small amount of a sulfur component, for example, with a sulfur content of 0.1% by mass or less, is included in the solid electrolyte containing no sulfur. The halide solid electrolyte may further contain oxygen as an anion other than the halogen element.

The halide solid electrolyte contains, for example, Li, M, and X. Mis at least one selected from the group consisting of a metal element and a metalloid element other than Li. X is at least one selected from the group consisting of F, Cl, Br, and I. The halide solid electrolyte has high thermal stability and can therefore improve the safety of the battery. Furthermore, the halide solid electrolyte does not contain sulfur and can therefore suppress the generation of hydrogen sulfide gas.

The term “metalloid element”, as used herein, refers to B, Si, Ge, As, Sb, or Te.

The tern “metal element”, as used herein, refers to any element except hydrogen in Groups 1 to 12 of the periodic table or any element in Groups 13 to 16 of the periodic table except B, Si, Ge, As, Sb, Te, C, N, P, O, S, and Se.

More specifically, the “metalloid element” and the “metal element”, as used herein, refers to a group of elements that can become cations when forming an inorganic compound with a halogen element.

For example, the halide solid electrolyte as the first solid electrolyte may be a material represented by the following composition formula (1).

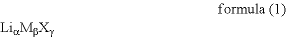

In the composition formula (1), α, β, and γ each independently denotes a value greater than 0. γ may be 4, 6, or the like.

The above configuration improves the ionic conductivity of the halide solid electrolyte and can therefore improve the ionic conductivity of an electrode sheet formed from the electrode composition 1000. When used in a battery, this electrode sheet can further improve the output characteristics of the battery.

The halide solid electrolyte as the first solid electrolyte may be represented by the following composition formula (2).

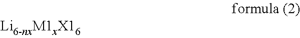

In the composition formula (2), x satisfies 0<x≤1.2. n denotes the weighted average valence of the elements contained in M1. M1 denotes a metal or a metalloid. X1 denotes at least one selected from the group consisting of F, Cl, Br, and I.

M1 may be at least one selected from the group consisting of Ca, Mg, Al, Y, Ti, and Zr. More specifically, M1 may be at least one selected from the group consisting of Al, Y, and Ti. The conduction path of lithium ions can be expanded by adding the above element that is a polyvalent ion with a valence of 3 or 4 to a crystal structure containing Li and X. Such a configuration can improve the ionic conductivity of the coating layer 102 and effectively reduce the resistance of the battery.

To further increase the ionic conductivity of the first solid electrolyte, in the halide solid electrolyte, the ratio of the amount of substance of Li to the total amount of substance of M1 may be 1.7 or more and 4.2 or less. When the ratio of the amount of substance of Li to the total amount of substance of M1 is the above ratio, the ionic conductivity of the first solid electrolyte can be further increased.

The halide solid electrolyte as the first solid electrolyte may consist essentially of Li, Ti, Al, and X1. The phrase “the halide solid electrolyte consists essentially of Li, Ti, Al, and X” means that the mole ratio (that is, mole fraction) of the total amount of substance of Li, Ti, Al, and X1 to the total amount of substance of all the elements constituting the halide solid electrolyte is 90% or more. As an example, the mole ratio (that is, mole fraction) may be 95% or more. The halide solid electrolyte may consist only of Li, Ti, Al, and X1.

X1 may contain fluorine (F). The halide solid electrolyte containing fluorine has high electrochemical stability and can therefore improve the cycle characteristics of the battery.

The halide solid electrolyte as the first solid electrolyte may be a material represented by the following composition formula (3).

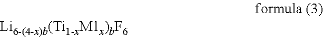

In the composition formula (3), 0<x<1 and 0<b≤1.5 are satisfied. The halide solid electrolyte having such a composition has high ionic conductivity.

To further increase the ionic conductivity of the halide solid electrolyte, M1 in the composition formula (3) may be Al.

To further increase the ionic conductivity of the halide solid electrolyte, 0.1≤x≤0.9 may be satisfied in the composition formula (3).

In the composition formula (3), 0.1≤x≤0.7 may be satisfied.

The upper limit and the lower limit of the range of x in the composition formula (3) can be defined by any combination of numerical values selected from 0.1, 0.3, 0.4, 0.5, 0.6, 0.67, 0.7, 0.8, and 0.9.

To further increase the ionic conductivity of the halide solid electrolyte, 0.8≤b≤1.2 may be satisfied in the composition formula (3).

The upper limit and the lower limit of the range of b in the composition formula (3) can be defined by any combination of numerical values selected from 0.8, 0.9, 0.94, 1.0, 1.06, 1.1, and 1.2.

The halide solid electrolyte may be a compound containing Li, M2, O (oxygen), and X2. The element M2 includes, for example, at least one selected from the group consisting of Nb and Ta. X2 denotes at least one selected from the group consisting of F, Cl, Br, and I.

The compound containing Li, M2, X2, and O (oxygen) may be represented, for example, by the composition formula: Li_{c}M2O_{d}X_{25+c-2d}. c may satisfy 0.1<c<7.0. d may satisfy 0.4<d<1.9.

More specifically, the halide solid electrolyte is, for example, Li₃Y(Cl, Br, I)₆, Li_{2.7}Y_{1.1}(Cl, Br, I)₆, Li₂Mg(F, Cl, Br, I)₄, Li₂Fe(F, Cl, Br, I)₄, Li(Al, Ga, In)(F, Cl, Br, I)₄, Li₃(Al, Ga, In)(F, Cl, Br, I)₆, Li₃(Ca, Y, Gd)(Cl, Br, I)₆, Li_{2.7}(Ti, Al)F₆, Li_{2.5}(Ti, Al)F₆, Li(Ta, Nb)O(F, Cl)₄, or the like. In the present disclosure, when an element in a formula is represented as “(Al, Ga, In)”, this notation indicates at least one element selected from the element group in the parentheses. For example, “(Al, Ga, In)” is synonymous with “at least one selected from the group consisting of Al, Ga, and In”. The same applies to other elements.

A sulfide solid electrolyte as the first solid electrolyte is, for example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or the like. LiX, Li₂O, MO_{q}, LipMO_{q}, or the like may be added to such a sulfide solid electrolyte. The element X in “LiX” is at least one selected from the group consisting of F, Cl, Br, and I. The element Min “MO_{q}” and “LipMO_{q}” is at least one selected from the group consisting of P, Si, Ge, B, Al, Ga, In, Fe, and Zn. p and q in “MO_{q}” and “LipMO_{q}” each independently denote a natural number. The sulfide solid electrolyte may be of a glass ceramic type or an argyrodite type.

The sulfide solid electrolyte may be, for example, a Li₂S—P₂S₅ glass ceramic. LiX, Li₂O, MO_{q}, LipMO_{q}, or the like may be added to the Li₂S—P₂S₅ glass ceramic, and two or more selected from LiCl, LiBr, and LiI may be added to the Li₂S—P₂S₅ glass ceramic. The Li₂S—P₂S₅ glass ceramic is a relatively soft material, and an electrode sheet containing the Li₂S—P₂S₅ glass ceramic can therefore be used to produce a battery with higher output power.

In addition to the halide solid electrolyte or the sulfide solid electrolyte that is the first solid electrolyte contained in the coating layer 102, an oxide material, an oxide solid electrolyte, a polymeric solid electrolyte, and a complex hydride solid electrolyte may be contained. For example, in the coating layer 102 containing the first solid electrolyte, the first solid electrolyte and the above-described material or electrolyte other than the first solid electrolyte may be mixed in one layer. In this case, the coating layer 102 may contain the first solid electrolyte as a main component, and materials other than the first solid electrolyte may be the remaining components.

The oxide material used for the coating material may be SiO₂, Al₂O₃, TiO₂, B₂O₃, Nb₂O₅, WO₃, ZrO₂, or the like.

The “oxide solid electrolyte”, as used herein, refers to a solid electrolyte containing oxygen. The oxide solid electrolyte may further include an anion other than sulfur and halogen elements as an anion other than oxygen.

The oxide solid electrolyte may be, for example, LiTi₂(PO₄)₃ or a NASICON-type solid electrolyte represented by an element-substituted product thereof, a (LaLi)TiO₃ perovskite solid electrolyte, Li₁₄ZnGe₄O₁₆, Li₄SiO₄, LiGeO₄ or a LISICON-type solid electrolyte represented by an element-substituted product thereof, Li₂La₃Zr₂O₁₂ or a garnet solid electrolyte represented by an element-substituted product thereof, Li₃PO₄ or a N-substituted product thereof, a glass based on a Li—B—O compound, such as LiBO₂ or Li₃BO₃, to which Li₂SO₄, Li₂CO₃, or the like is added, a glass ceramic, or the like.

The oxide solid electrolyte used for the coating material is, for example, a Li—Nb—O compound, such as LiNbO₃, a Li—B—O compound, such as LiBO₂ or Li₃BO₃, a Li—Al—O compound, such as LiAlO₂, a Li—Si—O compound, such as Li₄SiO₄, a Li—Ti—O compound, such as Li₂SO₄ or Li₄TisO₁₂, a Li—Zr—O compound, such as Li₂ZrO₃, a Li—Mo—O compound, such as Li₂MoO₃, a Li—V—O compound, such as LiV₂O₅, a Li—W—O compound, such as Li₂WO₄, a Li—P—O compound, such as LiPO₄, or the like. The oxide solid electrolyte has high potential stability. Thus, the oxide solid electrolyte can be used as the coating material to improve the cycle performance of the battery.

The polymeric solid electrolyte may be, for example, a compound of a polymer and a lithium salt. The polymer may have an ethylene oxide structure. A polymer with an ethylene oxide structure can contain a large amount of a lithium salt. This can further improve the ionic conductivity. The lithium salt may be LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), LiC(SO₂CF₃)₃, or the like. When a lithium salt is used, only one lithium salt may be used alone, or two or more lithium salts may be used in combination.

The complex hydride solid electrolyte may be, for example, LiBH₄—LiI, LiBH₄—P₂S₅, or the like.

The shapes of the particles of the first solid electrolyte and the above-described material or electrolyte other than the first solid electrolyte may be, but are not limited to, needle-like, spherical, ellipsoidal, or the like. The shape of the solid electrolyte may be particulate.

When the shape of the first solid electrolyte is, for example, particulate (for example, spherical), the first solid electrolyte may have a median diameter of 0.01 μm or more and 100 μm or less.

For example, the thickness of the coating layer 102 may be 1 nm or more and may be 500 nm or less. When the thickness of the coating layer 102 is adjusted to the above-described thickness, contact between the active material 101 and another material can be sufficiently suppressed. The thickness of the coating layer 102 can be determined by forming a thin piece of the coated active material 111 by ion milling or the like and observing a cross section of the coated active material 111 with a transmission electron microscope. An average value of thicknesses measured at a plurality of arbitrary positions (for example, five points) can be regarded as the thickness of the coating layer 102.

The coating layer 102 may be composed of one layer. For example, the coating layer 102 may be a single coating layer composed only of one type of the first solid electrolyte. Alternatively, the coating layer 102 may be, for example, a single coating layer composed of a material selected from a plurality of types of the first solid electrolytes. The coating layer 102 may be composed of a plurality of layers. The coating layer 102 may be, for example, a plurality of coating layers each composed of a material selected from a plurality of types of the first solid electrolytes. Alternatively, the coating layer 102 may have two layers including a layer composed of a halide solid electrolyte and a layer composed of a sulfide solid electrolyte. Such a configuration can improve both the cycle characteristics and the output characteristics of the battery.

When a plurality of coating layers 102 are provided, the outermost layer of the coating layer 102 may be composed of a layer containing the first solid electrolyte. When the outermost layer contains the first solid electrolyte, the outermost layer does not necessarily contain the oxide solid electrolyte. When the outermost layer does not contain the oxide solid electrolyte, the coating layer 102 further contains a large amount of a first solid electrolyte having a high affinity with a styrene elastomer contained in the binder 103 described later. Thus, the effect of improving the flowability is enhanced by providing the coating layer 102 as the outermost layer that is highly likely to come into contact with the styrene elastomer contained in the binder 103. The coating layer 102 contains a first solid electrolyte having a high affinity for the styrene elastomer contained in the binder 103 described later. Thus, the effect of improving the flowability is enhanced by providing the coating layer 102 as the outermost layer that is highly likely to come into contact with the styrene elastomer contained in the binder 103. The inner layer of the coating layer 102 between the active material 101 and the outermost layer of the coating layer 102 is not particularly limited and may be composed of a layer containing a material other than the first solid electrolyte. The layer containing a material other than the first solid electrolyte may contain an oxide material, an oxide solid electrolyte, a polymeric solid electrolyte, or a complex hydride solid electrolyte. The material constituting the inner layer may be an oxide solid electrolyte, a polymeric solid electrolyte, or a complex hydride solid electrolyte. The layer containing the first solid electrolyte may be a layer containing the first solid electrolyte as a main component or may be a layer containing only the first solid electrolyte. The layer containing the material or electrolyte other than the first solid electrolyte may be a layer containing the material or electrolyte as a main component or may be a layer containing only the material or electrolyte.

The layer containing the first solid electrolyte is not necessarily the outermost layer and may be composed of, for example, the material or electrolyte other than the first solid electrolyte. When the outermost layer is a layer other than the layer containing a component other than the first solid electrolyte, and the inner layer in contact with the outermost layer is a layer containing the first solid electrolyte, for example, with respect to the surface area of the layer containing the first solid electrolyte, the outermost layer covers the surface of 80% or less of the surface area of the layer containing the first solid electrolyte.

The coating layer 102 is produced by, for example, the following method.

A powder of the active material 101 and a powder of the first solid electrolyte are mixed at an appropriate ratio to prepare a mixture. The mixture is milled to impart mechanical energy to the mixture. A mixing apparatus, such as a ball mill, can be used for the milling treatment. The milling treatment may be performed in a dry atmosphere and an inert atmosphere to suppress the oxidation of the material.

The coated active material 111 may be produced by a dry particle compositing method. The treatment by the dry particle compositing method includes applying at least one mechanical energy selected from the group consisting of impact, compression, and shear to the active material 101 and the first solid electrolyte. The active material 101 and the first solid electrolyte are mixed at an appropriate ratio.

An apparatus used in the production of the coated active material 111 may be, but is not limited to, an apparatus that can apply mechanical energy, such as impact, compression, or shear, to the mixture of the active material 101 and the first solid electrolyte. The apparatus that can apply mechanical energy may be a processing apparatus (a particle compositing apparatus), such as a ball mill, “Mechanofusion” (manufactured by Hosokawa Micron Corporation), “Nobilta” (manufactured by Hosokawa Micron Corporation), or “Balance Gran” (manufactured by Freund-Turbo Corporation).

“Mechanofusion” is a particle compositing apparatus that uses a dry mechanical compositing technique of applying strong mechanical energy to a plurality of different raw material powders. In Mechanofusion, mechanical energy of compression, shear, and friction is applied to a raw material powder charged between a rotating vessel and a press head. This can achieve particle compositing.

“Nobilta” is a particle compositing apparatus using a dry mechanical compositing technique developed from a particle compositing technique to perform compositing using nanoparticles as a raw material. Nobilta produces composite particles by applying mechanical energy of impact, compression, and shear to a plurality of types of raw material powders.

In “Nobilta”, in a horizontal cylindrical mixing vessel, a rotor disposed so as to have a predetermined gap between the rotor and the inner wall of the mixing vessel rotates at a high speed, and a process of forcibly passing the raw material powder through the gap is repeated multiple times. Thus, composite particles of the active material 101 and the first solid electrolyte can be produced by applying impact, compression, and shear forces to the mixture. The thickness of the coating layer 102, the specific surface area of the coated active material 111, and the like can be controlled by adjusting the conditions, such as the rotational speed of the rotor, the processing time, and/or the charge amount.

However, the processing using the above apparatus is not essential. The coated active material 111 may be produced by mixing the active material 101 and the first solid electrolyte using a mortar, a planetary mixer, a kneader, or the like. The mixing method may be either a dry method or a wet method using a solvent. The first solid electrolyte may be deposited on the surface of the active material 101 by a method, such as a spray method, a spray dry coating method, an electrodeposition method, an immersion method, or a mechanical mixing method using a dispersing apparatus.

### <Binder>

The binder 103 can improve the wettability of the active material 101, the solid electrolyte, and/or the coated active material 111 to the solvent 104 in the electrode composition 1000, thereby improving the dispersibility of the particles thereof. Furthermore, the binder 103 can improve dispersion stability by suppressing aggregation between particles of the active material 101, the solid electrolyte, and/or the coated active material 111 in the electrode composition 1000. The binder 103 can improve the adhesion between the particles of the active material 101, the solid electrolyte, and the coated active material 111 in the electrode sheet.

The binder 103 contains a styrene elastomer. The styrene elastomer refers to an elastomer containing a repeating unit derived from styrene. The repeating unit refers to a molecular structure derived from a monomer and may also be referred to as a constitutional unit. The styrene elastomer has high flexibility and elasticity and is therefore suitable for the binder 103 of the electrode sheet. The content of the repeating unit derived from styrene in the styrene elastomer is, for example, but not limited to, 10% by mass or more and 70% by mass or less.

The styrene elastomer may be a copolymer composed of butadiene or isoprene as a monomer of a conjugated diene. Some or all of the repeating unit derived from the conjugated diene may be hydrogenated. That is, the repeating unit derived from the conjugated diene may or may not have an unsaturated bond, such as a carbon-carbon double bond.

The styrene elastomer may be a block copolymer including a first block composed of a repeating unit derived from styrene and a second block composed of a repeating unit derived from a conjugated diene. The conjugated diene may be butadiene, isoprene, or the like. The repeating unit derived from the conjugated diene may be hydrogenated. That is, the repeating unit derived from the conjugated diene may or may not have an unsaturated bond, such as a carbon-carbon double bond. The block copolymer may have a triblock sequence composed of two first blocks and one second block. The block copolymer may be an ABA-type triblock copolymer. In this triblock copolymer, the A block corresponds to the first block, and the B block corresponds to the second block. The first block functions as, for example, a hard segment. The second block functions as, for example, a soft segment.

The styrene elastomer may be a styrene-ethylene/butylene-styrene block copolymer (SEBS), a styrene-ethylene/propylene-styrene block copolymer (SEPS), a styrene-ethylene/ethylene/propylene-styrene block copolymer (SEEPS), a styrene-butadiene rubber (SBR), a styrene-butadiene-styrene block copolymer (SBS), a styrene-isoprene-styrene block copolymer (SIS), a hydrogenated styrene-butadiene rubber (HSBR), or the like. The binder 103 may contain SBR or SEBS as the styrene elastomer. A mixture including two or more selected from these may be used as the binder 103. The styrene elastomer has high flexibility and elasticity, and the binder 103 containing the styrene elastomer can therefore improve the surface smoothness of an electrode sheet produced from the electrode composition 1000. Furthermore, the binder 103 containing the styrene elastomer can impart flexibility to the electrode sheet. This can improve the durability of the battery.

The styrene elastomer may be a styrene triblock copolymer. The styrene triblock copolymer may be a styrene-ethylene/butylene-styrene block copolymer (SEBS), a styrene-ethylene/propylene-styrene block copolymer (SEPS), a styrene-ethylene/ethylene/propylene-styrene block copolymer (SEEPS), a styrene-butadiene-styrene block copolymer (SBS), a styrene-isoprene-styrene block copolymer (SIS), or the like. These styrene triblock copolymers are sometimes referred to as styrene thermoplastic elastomers. These styrene triblock copolymers tend to be flexible and have high strength.

The styrene elastomer has a total nitrogen content of 30 ppm or more and 300 ppm or less. The styrene elastomer may have a total nitrogen content of 50 ppm or more and 250 ppm or less, or 80 ppm or more and 200 ppm or less. The total nitrogen content is determined using a total nitrogen microanalyzer. More specifically, the mass (μg) of nitrogen (N) contained in 1 g of a polymer is measured with a total nitrogen microanalyzer (TN-2100H) manufactured by Nittoseiko Analytech Co., Ltd. using a pyridine/toluene solution as a standard sample. The total nitrogen content is the proportion (μg/g=ppm) of the mass (μg) of nitrogen (N) contained in 1 g of a polymer.

A method for specifying the total nitrogen content of a styrene elastomer contained in a battery product is as described below. First, organic substances contained in an electrode of the battery product are extracted with an aromatic solvent, such as toluene, in which the styrene elastomer is soluble. Chromatography is then performed to isolate the styrene elastomer from the extracted organic substances. At this time, low-molecular-weight organic substances other than the styrene elastomer may be removed using gel permeation chromatography (GPC), and a GPC column that is more precise than the GPC may be used. At this time, the isolation may be confirmed by nuclear magnetic resonance analysis (NMR) and/or infrared absorption spectroscopic analysis (IR analysis). The isolated styrene elastomer solution is then subjected to trace total nitrogen analysis to determine the total nitrogen content of the styrene elastomer.

The styrene elastomer may contain a modifying group having a nitrogen atom. The term “modifying group” refers to a functional group that chemically modifies all repeating units included in a polymer chain, part of repeating units included in the polymer chain, or a terminal portion of the polymer chain. The modifying group can be introduced into the polymer chain by a substitution reaction, an addition reaction, or the like. The modifying group having a nitrogen atom is a functional group containing nitrogen, for example, an amino group, a nitrile group, a nitro group, or the like. The modifying group having a nitrogen atom can be introduced into the polymer chain by, for example, reacting a modifying agent. A compound serving as the modifying agent may be an amine compound, an isocyanate compound, an isothiocyanate compound, an isocyanuric acid derivative, a carbonyl compound containing a nitrogen group, a vinyl compound containing a nitrogen group, an epoxy compound containing a nitrogen group, an alkoxy silicon compound containing a nitrogen group, or the like. The position of the modifying group may be at an end of the polymer chain. A styrene elastomer having a modifying group at an end of the polymer chain can have an effect similar to that of a so-called surfactant. That is, when a styrene elastomer having a modifying group at an end of the polymer chain is used, the modifying group is adsorbed to an active material and/or a solid electrolyte, and the polymer chain can suppress aggregation of particles of the active material 101 and/or the solid electrolyte. This can further improve the dispersibility of the active material 101 and/or the solid electrolyte. The styrene elastomer may be, for example, a terminal amine-modified styrene elastomer. The styrene elastomer may be, for example, a styrene elastomer having a nitrogen atom at at least one end of the polymer chain and having a star polymer structure centered on an alkoxysilane substituent containing nitrogen.

The styrene elastomer may further have a modifying group having an atom other than a nitrogen atom in addition to the modifying group having a nitrogen atom. The modifying group having an atom other than a nitrogen atom may contain, for example, an element, such as O, S, F, Cl, Br, or F having a relatively high electronegativity, or Si, Sn, or P having a relatively low electronegativity. A modifying group containing such an element can impart polarity to the styrene elastomer. The modifying group may be a carboxylic acid group, an acid anhydride group, an acyl group, a hydroxy group, a sulfo group, a sulfanyl group, a phosphoric acid group, a phosphonic acid group, an isocyanate group, an epoxy group, a silyl group, or the like. A specific example of the acid anhydride group is a maleic anhydride group. The modifying group may be a functional group that can be introduced by reacting a modifying agent with the following compound. A compound serving as the modifying agent may be an epoxy compound, an ether compound, an ester compound, a mercapto group derivative, a thiocarbonyl compound, a silicon halide compound, an epoxidized silicon compound, a vinylated silicon compound, an alkoxy silicon compound, a tin halide compound, an organotin carboxylate compound, a phosphite compound, a phosphino compound, or the like. When having the modifying group, the styrene elastomer can further improve the dispersibility of the active material 101 and/or the solid electrolyte contained in the electrode composition 1000. Furthermore, through the interaction with a current collector, the peel strength of an electrode sheet can be improved.

The styrene elastomer may have a weight-average molecular weight (Mw) of 200,000 or more. The styrene elastomer may have a weight-average molecular weight (Mw) of 300,000 or more, 500,000 or more, 800,000 or more, or 1,000,000 or more. The upper limit of the weight-average molecular weight (Mw) is, for example, 1,500,000. When the styrene elastomer has a weight-average molecular weight (Mw) of 200,000 or more, an excessive increase in the total nitrogen content of the styrene elastomer can be suppressed. Furthermore, particles of the active material 101 and/or the solid electrolyte can be bonded to each other with sufficient adhesive strength. When the styrene elastomer has a weight-average molecular weight (Mw) of 1,500,000 or less, the electronic conduction between particles of the active material 101 and/or the ionic conduction between particles of the solid electrolyte is less likely to be inhibited by the binder 103, and the output characteristics of the battery can be improved. The weight-average molecular weight (Mw) of the styrene elastomer in the binder 103 can be specified by, for example, gel permeation chromatography (GPC) measurement using polystyrene as a standard sample. In other words, the weight-average molecular weight (Mw) is a value in terms of polystyrene. In the GPC measurement, chloroform may be used as an eluent. When two or more peak tops are observed in a chart obtained by the GPC measurement, the weight-average molecular weight (Mw) calculated from the entire peak range including each peak top can be regarded as the weight-average molecular weight (Mw) of the styrene elastomer.

In the styrene elastomer, the ratio of the degree of polymerization of a repeating unit derived from styrene to the degree of polymerization of a repeating unit derived from a monomer other than styrene is defined as m:n. At this time, in the styrene elastomer, the mole fraction (hereinafter also referred to simply as “φ”) of the repeating unit derived from styrene can be calculated by φ=m/(m+n). In the styrene elastomer, the mole fraction (φ) of the repeating unit derived from styrene can be determined by, for example, proton nuclear magnetic resonance (¹H NMR) measurement.

In the styrene elastomer, the mole fraction (φ) of the repeating unit derived from styrene may be 0.02 or more and 0.55 or less, or 0.1 or more and 0.3 or less. The styrene elastomer with φ of 0.02 or more can improve the strength of the electrode sheet. The styrene elastomer with φ of 0.55 or less can improve the flexibility of the electrode sheet.

The styrene elastomer may contain at least one selected from the group consisting of modified SEBS and modified SBR. The term “modified SEBS” refers to SEBS into which a modifying group is introduced. The term “modified SBR” refers to SBR into which a modifying group is introduced. The modifying group includes a modifying group having a nitrogen atom. The modifying group may further include a modifying group having an atom other than a nitrogen atom. The modified SEBS or modified SBR may be produced by solution polymerization or by solution anionic polymerization using an organolithium catalyst. Since the solution anionic polymerization is a production method good in controlling the molecular weight of the polymer and/or the amount of the modifying group to be introduced, a more optimal electrode composition 1000 can be produced by using a modified SEBS produced by the solution polymerization or a modified SBR produced by the solution polymerization.

The styrene elastomer may contain a modified SBR. The styrene elastomer may be a modified SBR. The modified SBR tends to be more easily compressed in hot pressing than the modified SEBS. This can further improve the filling characteristics of the ionic conductor 112 contained in an electrode sheet produced from the electrode composition 1000.

The styrene elastomer may be an oil-extended polymer in which a process oil or the like is blended to improve processability. The process oil is, for example, an aromatic oil, a paraffinic oil, a naphthenic oil, a vegetable oil, an oil with a low polycyclic aromatic compound content (a low PCA oil), or the like. The process oil may be a low PCA oil. The low PCA oil is, for example, a mild extraction solvate (MES), an oil produced by treating an aromatic extract from a distillate oil (TDAE), an aromatic special extract from a residual oil (SRAE), a heavy naphthenic oil, or the like. The ratio of the mass of the process oil to the mass of the styrene elastomer is, for example, but not limited to, 10% by mass or more and 100% by mass or less. When the binder 103 contains the process oil, the process oil serves as a lubricant and can improve the filling characteristics of the ionic conductor 112.

The ratio of the mass of the process oil to the mass of the styrene elastomer may be 1% by mass or less. Setting the ratio of the mass of the process oil to the mass of the styrene elastomer to 1% by mass or less can suppress the reaction between the process oil and the solid electrolyte and improve the cycle characteristics of the battery. When the styrene elastomer is an oil-extended polymer, the oil in the styrene elastomer can be removed by dissolving the styrene elastomer in tetrahydrofuran (THF) and then performing washing by reprecipitation in ethanol and reprecipitation in acetone.

The binder 103 may contain a resin binder other than the styrene elastomer, such as a binder that can be generally used as a binder for batteries. Alternatively, the binder 103 may be a styrene elastomer. In other words, the binder 103 may contain only the styrene elastomer.

The binder may be poly(vinylidene difluoride) (PVDF), polytetrafluoroethylene (PTFE), polyethylene, polypropylene, aramid resin, polyamide, polyimide, polyamideimide, polyacrylonitrile, poly(acrylic acid), poly(methyl acrylate), poly(ethyl acrylate), poly(hexyl acrylate), poly(methacrylic acid), poly(methyl methacrylate) (PMMA), poly(ethyl methacrylate), poly(hexyl methacrylate), poly(vinyl acetate), polyvinylpyrrolidone, polyether, polycarbonate, poly(ether sulfone), poly(ether ketone), poly(ether ether ketone), poly(phenylene sulfide), hexafluoropolypropylene, styrene-butadiene rubber, carboxymethyl cellulose, ethyl cellulose, or the like. The binder may be a copolymer synthesized from two or more monomers selected from the group consisting of tetrafluoroethylene, hexafluoroethylene, hexafluoropropylene, perfluoroalkyl vinyl ether, vinylidene fluoride, chlorotrifluoroethylene, ethylene, propylene, butadiene, isoprene, styrene, pentafluoropropylene, fluoromethyl vinyl ether, acrylate, acrylic acid, and hexadiene. These may be used alone or in combination of two or more types thereof.

The binder may contain an elastomer from the perspective of a good binding property. The term “elastomer” refers to a polymer having rubber elasticity. The elastomer used as the binder may be a thermoplastic elastomer or a thermosetting elastomer. In addition to the above-described styrene elastomer, the elastomer may be butadiene rubber (BR), isoprene rubber (IR), chloroprene rubber (CR), acrylonitrile-butadiene rubber (NBR), hydrogenated isoprene rubber (HIR), hydrogenated butyl rubber (HIIR), hydrogenated nitrile rubber (HNBR), acrylate butadiene rubber (ABR), or the like. A mixture including two or more selected from these may be used.

### <Ionic Conductor>

As described above, the ionic conductor 112 includes the coated active material 111 and the binder 103. In the ionic conductor 112, particles of the coated active material 111 are bound via the styrene elastomer contained in the binder 103. In the ionic conductor 112, the particles of the coated active material 111 are uniformly dispersed by, for example, the styrene elastomer contained in the binder 103 adsorbed to the coated active material 111.

In the ionic conductor 112, the ratio of the mass of the binder 103 to the mass of the coated active material 111 may be, but is not limited to, 0.1% by mass or more and 10% by mass or less, 0.2% by mass or more and 5% by mass or less, or 0.3% by mass or more and 1% by mass or less. When the ratio of the mass of the binder 103 to the mass of the coated active material 111 is 0.1% by mass or more, the strength of an electrode sheet produced from the electrode composition 1000 can be improved. When the ratio of the mass of the binder 103 to the mass of the coated active material 111 is 10% by mass or less, a decrease in the ionic conductivity of the ionic conductor 112 can be suppressed.

The ionic conductor 112 can be produced by, for example, mixing the coated active material 111 and the binder 103. A method for mixing these is, for example, but not limited to, a method for mechanically pulverizing and mixing the coated active material 111 and the binder 103 in a dry manner. A wet method for preparing a solution or a dispersion liquid containing the binder 103, dispersing the coated active material 111 in the solution or the dispersion liquid, and mixing them may also be employed. The binder 103 and the coated active material 111 can be easily and uniformly mixed by the wet method. The electrode composition 1000 may be produced by producing the ionic conductor 112 in the solvent 104 by the wet method.

### <Solvent>

The solvent 104 may be an organic solvent. The organic solvent is a compound containing carbon, for example, a compound containing an element, such as carbon, hydrogen, nitrogen, oxygen, sulfur, or halogen.

The solvent 104 may contain at least one selected from the group consisting of a hydrocarbon, a compound having a halogen group, and a compound having an ether bond.

The hydrocarbon is a compound consisting only of carbon and hydrogen. The hydrocarbon may be an aliphatic hydrocarbon. The hydrocarbon may be a saturated hydrocarbon or an unsaturated hydrocarbon. The hydrocarbon may be linear or branched. The number of carbons in the hydrocarbon may be, but is not limited to, 7 or more. The hydrocarbon can be used to produce the electrode composition 1000 having good dispersibility of the ionic conductor 112. Furthermore, a decrease in the ionic conductivity of the ionic conductor 112 due to mixing with the solvent 104 can be suppressed.

The hydrocarbon may have a ring structure. The ring structure may be an alicyclic hydrocarbon or an aromatic hydrocarbon. The ring structure may be monocyclic or polycyclic. When the hydrocarbon has a ring structure, the ionic conductor 112 can be easily dispersed in the solvent 104. From the perspective of improving the dispersibility of the ionic conductor 112 in the electrode composition 1000, the hydrocarbon may contain an aromatic hydrocarbon. That is, the solvent 104 may contain the aromatic hydrocarbon. The hydrocarbon may be the aromatic hydrocarbon. The styrene elastomer is easily dissolved in the aromatic hydrocarbon. Thus, when the binder 103 contains the styrene elastomer and the solvent 104 contains the aromatic hydrocarbon, the binder 103 can be more efficiently adsorbed to the coated active material 111 in the electrode composition 1000. This makes it possible to further improve the performance of holding the solvent of the electrode composition 1000. The aromatic hydrocarbon has a relatively low polarity. Thus, when the solvent 104 contains the aromatic hydrocarbon, excessive adsorption of the solvent 104 to the coated active material 111 can be suppressed. Furthermore, when the solvent 104 contains the aromatic hydrocarbon, a decrease in ionic conductivity due to a reaction between the solid electrolyte and the solvent 104 can be suppressed.

In the compound having a halogen group, the portion other than the halogen group may be composed only of carbon and hydrogen. That is, the term “compound having a halogen group” refers to a compound in which at least one hydrogen atom in a hydrocarbon is substituted with a halogen group. The halogen group may be F, Cl, Br, or I. The halogen group may be at least one selected from the group consisting of F, Cl, Br, and I. At least one hydrogen atom in the hydrocarbon can be substituted with a halogen group to provide a hydrocarbon with a relatively low polarity. A compound having a halogen group can be used for the solvent 104 to easily disperse the ionic conductor 112 in the solvent 104 and produce the electrode composition 1000 having good dispersibility. Consequently, an electrode sheet produced from the electrode composition 1000 may have high ionic conductivity and a denser structure.

The number of carbons in the compound having a halogen group may be, but is not limited to, 7 or more. Thus, the compound having a halogen group is less likely to volatilize, and the electrode composition 1000 can be stably produced. The compound having a halogen group may have a large molecular weight. That is, the compound having a halogen group may have a high boiling point.

The compound having a halogen group may have a ring structure. The ring structure may be an alicyclic hydrocarbon or an aromatic hydrocarbon. The ring structure may be monocyclic or polycyclic. When the compound having a halogen group has the ring structure, the ionic conductor 112 can be easily dispersed in the solvent 104. From the perspective of enhancing the dispersibility of the ionic conductor 112 in the electrode composition 1000, the compound having a halogen group may contain an aromatic hydrocarbon. The compound having a halogen group may be an aromatic hydrocarbon substituted with a halogen group.

The compound having a halogen group may have only a halogen group as a functional group. In this case, the number of halogens in the compound having a halogen group is not particularly limited. The halogen group may be at least one selected from the group consisting of F, Cl, Br, and I. Such a compound can be used for the solvent 104 to easily disperse the ionic conductor 112 in the solvent 104 and produce the electrode composition 1000 having good dispersibility. Consequently, an electrode sheet produced from the electrode composition 1000 may have high ionic conductivity and a denser structure. By using such a compound for the solvent 104, an electrode sheet produced from the electrode composition 1000 can easily have a dense structure with few pinholes, irregularities, and the like.

The compound having a halogen group may be a halogenated hydrocarbon. The term “halogenated hydrocarbon” refers to a compound in which all hydrogens in a hydrocarbon are substituted with a halogen group. The halogenated hydrocarbon can be used for the solvent 104 to easily disperse the ionic conductor 112 in the solvent 104 and produce the electrode composition 1000 having good dispersibility. Consequently, an electrode sheet produced from the electrode composition 1000 may have high ionic conductivity and a denser structure. By using such a compound for the solvent 104, an electrode sheet produced from the electrode composition 1000 can easily have, for example, a dense structure with few pinholes, irregularities, and the like.

In the compound having an ether bond, the portion other than the ether bond may be composed only of carbon and hydrogen. That is, the term “compound having an ether bond” refers to a compound in which at least one C—C bond in a hydrocarbon is substituted with a C—O—C bond. At least one C—C bond in a hydrocarbon can be substituted with a C—O—C bond to provide the hydrocarbon with a relatively low polarity. The compound having an ether bond can be used for the solvent 104 to easily disperse the ionic conductor 112 in the solvent 104. Thus, the electrode composition 1000 having good dispersibility can be produced. Consequently, an electrode sheet produced from the electrode composition 1000 may have high ionic conductivity and a denser structure.

The compound having an ether bond may have a ring structure. The ring structure may be an alicyclic hydrocarbon or an aromatic hydrocarbon. The ring structure may be monocyclic or polycyclic. When the compound having an ether bond has the ring structure, the ionic conductor 112 can be easily dispersed in the solvent 104. From the perspective of enhancing the dispersibility of the ionic conductor 112 in the electrode composition 1000, the compound having an ether bond may contain an aromatic hydrocarbon. The compound having an ether bond may be an aromatic hydrocarbon substituted with an ether group.

The solvent 104 may be ethylbenzene, mesitylene, pseudocumene, p-xylene, cumene, tetralin, m-xylene, dibutyl ether, 1,2,4-trichlorobenzene, chlorobenzene, 2,4-dichlorotoluene, anisole, o-chlorotoluene, m-dichlorobenzene, p-chlorotoluene, o-dichlorobenzene, 1,4-dichlorobutane, 3,4-dichlorotoluene, or the like. These may be used alone or in combination of two or more types thereof.

From the perspective of cost, the solvent 104 may be commercially available xylene, that is, mixed xylene. The solvent 104 may be, for example, mixed xylene in which o-xylene, m-xylene, p-xylene, and ethylbenzene are mixed at a mass ratio of 24:42:18:16.

The solvent 104 may contain tetralin. Tetralin has a relatively high boiling point. Tetralin not only improves the performance of holding the solvent of the electrode composition 1000 but also enables stable production of the electrode composition 1000 by a kneading process.

The solvent 104 may have a boiling point of 100° C. or more and 250° C. or less, 130° C. or more and 230° C. or less, 150° C. or more and 220° C. or less, or 180° C. or more and 210° C. or less. The solvent 104 may be a liquid at normal temperature (25° C.). Since such a solvent is less likely to volatilize at normal temperature, the electrode composition 1000 can be stably produced. Thus, the electrode composition 1000 that can be easily applied to the surface of the substrate is produced. The solvent 104 in the electrode composition 1000 can be easily removed by drying described later.

The solvent 104 may have a water content of 10 ppm by mass or less. The water content can be reduced to suppress a decrease in ionic conductivity due to the reaction of a solid electrolyte. The water content may be reduced by a dehydration method using a molecular sieve, a dehydration method by bubbling using an inert gas, such as nitrogen gas or argon gas, or the like. The dehydration method by bubbling using an inert gas is recommended from the perspective that oxygen can be removed simultaneously with water. The water content can be measured using a Karl Fischer moisture meter.

The solvent 104 disperses the ionic conductor 112. The solvent 104 may be a liquid that can disperse the coated active material 111. The coated active material 111 is not necessarily dissolved in the solvent 104. When the coated active material 111 is not dissolved in the solvent 104, the electrode composition 1000 in which an ion-conducting phase formed at the time of producing the first solid electrolyte contained in the coating layer 102 of the coated active material 111 is maintained can be produced. Thus, an electrode sheet produced from the electrode composition 1000 can suppress a decrease in ionic conductivity.

The solvent 104 may dissolve part of the coated active material 111. The coated active material 111 can be dissolved to improve the denseness of an electrode sheet produced from the electrode composition 1000.

### <Electrode Composition>

The electrode composition 1000 may be in the form of a paste or a dispersion liquid. The coated active material 111 is, for example, particles. In the production of the electrode composition 1000, particles of the ionic conductor 112 are mixed with the solvent 104. In the production of the electrode composition 1000, the method for mixing the ionic conductor 112 and the solvent 104, that is, the method for mixing the coated active material 111, the binder 103, and the solvent 104, is not particularly limited. For example, a mixing method using a mixing apparatus of a stirring type, a shaking type, an ultrasonic type, a rotation type, or the like is mentioned. For example, a mixing method using a dispersion mixer, such as a high-speed homogenizer, a thin-film rotary high-speed mixer, an ultrasonic homogenizer, a ball mill, a bead mill, a planetary mixer, a sand mill, a rolling mill, a kneader, or the like is mentioned. One of these mixing methods may be used alone or in combination.

The electrode composition 1000 is produced by, for example, the following method. First, the coated active material 111 and the solvent 104 are mixed, and a binder solution is further added thereto. The resulting liquid mixture is subjected to a high-speed shear treatment using an in-line disperser/pulverizer. A binder solution is added to the resulting dispersion liquid. The resulting liquid mixture is subjected to a high-speed shear treatment using an in-line disperser/pulverizer. Through such a step, the ionic conductor 112 is formed, and the ionic conductor 112 is dispersed and stabilized in the solvent 104, so that the electrode composition 1000 having higher flowability can be produced. The electrode composition 1000 may also be produced by mixing the solvent 104 and the ionic conductor 112 produced in advance and subjecting the resulting liquid mixture to a high-speed shear treatment.

The electrode composition 1000 may be produced, for example, by the following method. First, the coated active material 111 and the solvent 104 are mixed, and a binder solution is further added thereto. The resulting liquid mixture is subjected to a high shear treatment using an ultrasonic homogenizer. A binder solution is added to the resulting dispersion liquid. The resulting liquid mixture is subjected to a high shear treatment using an ultrasonic homogenizer. Through such a step, the ionic conductor 112 is formed, and the ionic conductor 112 is dispersed and stabilized in the solvent 104, so that the electrode composition 1000 having higher flowability can be produced. The electrode composition 1000 may also be produced by mixing the solvent 104 and the ionic conductor 112 produced in advance and subjecting the resulting liquid mixture to a high-speed shear treatment using ultrasonic waves.

From the perspective of producing the electrode composition 1000 having high flowability, the high-speed shear treatment or the high shear treatment using ultrasonic waves may be performed under the conditions that pulverization of particles of the coated active material 111 is avoided while deagglomeration of particles of the coated active material 111 is achieved.

The binder solution is, for example, a solution containing the binder 103 and the solvent 104. The composition of the solvent contained in the binder solution may be the same as or different from the composition of the solvent contained in the dispersion liquid of the coated active material 111.

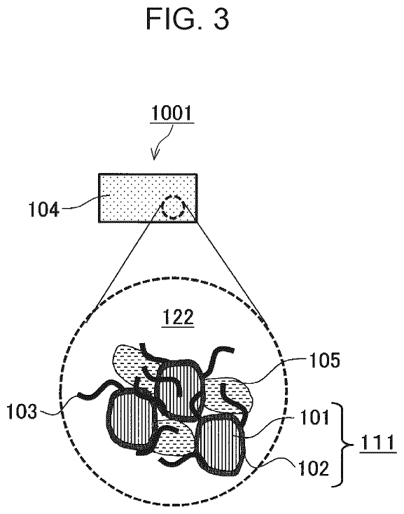

FIG. 3 is a schematic view of an electrode composition 1001 according to a modified example. The electrode composition 1001 contains an ionic conductor 122 and the solvent 104. The ionic conductor 122 contains the coated active material 111, a second solid electrolyte 105, and the binder 103. That is, the electrode composition 1001 is the electrode composition 1000 to which the second solid electrolyte 105 is further added to improve the ionic conductivity. The second solid electrolyte may be the same material as the first solid electrolyte or may include the above-described solid electrolyte different from the first solid electrolyte. For example, a halide solid electrolyte may be used as the first solid electrolyte contained in the coating layer 102 of the coated active material 111, and a sulfide solid electrolyte may be used as the second solid electrolyte.

When the shape of the second solid electrolyte 105 is particulate (for example, spherical), the second solid electrolyte may have a median diameter of 1 μm or more and 100 μm or less, or 1 μm or more and 10 μm or less. When the second solid electrolyte 105 has a median diameter of 1 μm or more and 100 μm or less, the second solid electrolyte 105 can be easily dispersed in the solvent 104.

When the shape of the second solid electrolyte 105 is particulate (for example, spherical), the second solid electrolyte 105 may have a median diameter of 0.1 μm or more and 5 μm or less, or 0.5 μm or more and 3 μm or less. When the second solid electrolyte 105 has a median diameter of 0.1 μm or more and 5 μm or less, an electrode sheet produced from the electrode composition 1001 can have higher surface smoothness and a denser structure.

The second solid electrolyte 105 may have a specific surface area of 0.1 m²/g or more and 100 m²/g or less, or 1 m²/g or more and 10 m²/g or less. When the second solid electrolyte 105 has a specific surface area of 0.1 m²/g or more and 100 m²/g or less, the second solid electrolyte 105 can be easily dispersed in the solvent 104. The specific surface area can be measured by a BET multipoint method using a gas adsorption amount measuring apparatus.

The second solid electrolyte 105 may have an ionic conductivity of 0.01 mS/cm² or more, 0.1 mS/cm² or more, or 1 mS/cm² or more. When the second solid electrolyte 105 has an ionic conductivity of 0.01 mS/cm² or more, the battery output characteristics can be improved.

The electrode composition 1000 or 1001 may contain a conductive additive to improve electronic conductivity. The conductive additive may be graphite, such as natural graphite or artificial graphite, carbon black, such as acetylene black or Ketjen black, electrically conductive fiber, such as carbon fiber or metal fiber, electrically conductive powder, such as fluorocarbon or aluminum, electrically conductive whisker, such as zinc oxide or potassium titanate, electrically conductive metal oxide, such as titanium oxide, electrically conductive polymer, such as polyaniline, polypyrrole, or polythiophene, or the like. The use of a carbon material as the conductive additive can reduce the cost of the electrode composition 1000 or 1001.

The electrode composition 1000 may contain a dispersant to improve the dispersibility of the coated active material 111. Similarly, the electrode composition 1001 may contain a dispersant to improve the dispersibility of the coated active material 111 and the second solid electrolyte 105. The dispersant may be a low-molecular-weight dispersant or a high-molecular-weight dispersant. The dispersant may be, for example, a commercially available dispersant, wetting agent, or surfactant.

The electrode composition 1000 or 1001 may contain an amine compound as a dispersant. The amine compound is suitable for improving the dispersibility of a solid electrolyte. The amine compound is, for example, an aliphatic amine, such as methylamine or dimethylamine, an aromatic amine, such as aniline, a heterocyclic amine, such as imidazole or imidazoline, or the like.

The electrode composition 1000 or 1001 may contain imidazoline or an imidazoline derivative as a dispersant. Imidazoline or an imidazoline derivative is more suitable for improving the dispersibility of an active material and/or a solid electrolyte. The imidazoline derivative is, for example, 1-hydroxyethyl-2-alkenylimidazoline or the like.

In the electrode composition 1001, the ratio of the mass of the second solid electrolyte 105 to the mass of the coated active material 111 is, for example, but not limited to, 10% by mass or more and 150% by mass or less, 20% by mass or more and 100% by mass or less, or 30% by mass or more and 70% by mass or less. When the ratio of the mass of the second solid electrolyte 105 is 10% by mass or more, the electrode composition 1001 can improve the ionic conductivity and provide a battery with a higher power. When the ratio of the mass of the second solid electrolyte 105 is 150% by mass or less, a battery with a higher energy density can be provided.

The solid concentration (NV) of the electrode composition 1000 or 1001 is appropriately determined according to the particle size of the coated active material 111, the specific surface area of the coated active material 111, the particle size of the second solid electrolyte 105, the specific surface area of the second solid electrolyte 105, the type of the solvent 104, and the type of the binder 103. The electrode composition 1000 or 1001 may have a solid concentration of 40% by mass or more and 90% by mass or less, or 50% by mass or more and 80% by mass or less. The electrode composition 1000 or 1001 with a solid concentration of 40% by mass or more can have an increased viscosity and is less likely to sag when applied to a substrate. The electrode composition 1000 or 1001 with a solid concentration of 90% by mass or less can have a relatively large wet film thickness when applied to a substrate and can provide an electrode sheet with a more uniform thickness.

The flowability of the electrode composition 1000 or 1001 can be evaluated based on the viscosity ratio determined using a viscosity/viscoelasticity measuring instrument. Alternatively, the flowability of the electrode composition 1000 or 1001 may be evaluated by evaluating rheology using a viscosity/viscoelasticity measuring instrument.

The flowability of the electrode composition 1000 or 1001 can be evaluated by, for example, the following method. The viscosity of the electrode composition 1000 or 1001 measured using a viscosity/viscoelasticity measuring instrument in a speed control mode under the conditions of 25° C. and a shear rate of 1/s is defined as viscosity η₁. The viscosity of the electrode composition 1000 or 1001 measured using a viscosity/viscoelasticity measuring instrument in a speed control mode under the conditions of 25° C. and a shear rate of 100/s is defined as viscosity η₂. The flowability of the electrode composition 1000 or 1001 can be evaluated as the ratio η₁/η₂ of the viscosity η₁ to the viscosity η₂.

In the electrode composition 1000 or 1001, η₁/η₂ may be 1.3 or more. η₁/η₂ of 1.3 or more can result in the electrode composition 1000 or 1001 having further improved dispersion stability. This can also suppress sagging of the electrode composition 1000 or 1001 during application. The upper limit of η₁/η₂ is, for example, 30. η₁/η₂ of 30 or less can result in improved uniformity of the film thickness of an electrode sheet produced from the electrode composition 1000 or 1001.

Rheology may be evaluated to evaluate the flowability of the electrode composition 1000 or 1001. The rheology is evaluate, for example, using the Casson yield value.

In the electrode composition 1000 or 1001, the rheology may be evaluated using a Casson yield value determined using a viscosity/viscoelasticity measuring instrument in a speed control mode. The Casson yield value can be calculated by the following method. First, a viscosity/viscoelasticity measuring instrument is used to measure the shear stress(S) of the electrode composition 1000 or 1001 under the conditions of 25° C. and a speed control mode at a shear rate (D) in the range of 0.1/s to 1000/s. The resulting numerical value of the shear rate and the numerical value of the shear stress are used to determine a slope a and an intercept b based on the following relational expression. The Casson yield value is the square of the intercept b in the following relational expression.

$$√ S = a √ D + b$$

In the electrode composition 1000 or 1001, the Casson yield value may be 0.05 Pa or more and 4.5 Pa or less. When the Casson yield value is 0.05 Pa or more, the electrode composition 1000 or 1001 can be easily applied to a substrate. A Casson yield value of 4.5 Pa or less can result in the production of a coating film with a more uniform thickness.

### Second Embodiment

A second embodiment will be described below. The description overlapping with the first embodiment will be omitted as appropriate.

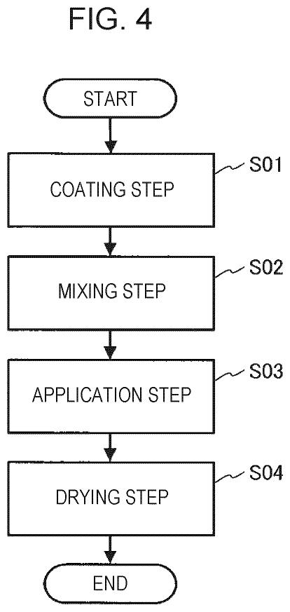

A method for producing an electrode sheet will be described below with reference to FIG. 4. FIG. 4 is a flow chart of a method for producing an electrode sheet. This shows a method for producing an electrode sheet using the electrode composition illustrated in FIG. 1 as an example.

The method for producing an electrode sheet may include a step S01, a step S02, a step S03, and a step S04. The method for producing an electrode sheet includes applying the electrode composition 1000 to a current collector, a substrate, or an electrode assembly to form a coating film and removing the solvent from the coating film. The step S01 and the step S02 in FIG. 4 have been described in the first embodiment. The method for producing an electrode sheet includes the step S03 of applying the electrode composition 1000 and the step S04 of drying the electrode composition 1000. The step S01, the step S02, the step S03, and the step S04 may be performed in this order. Through these steps, the electrode composition 1000 can be used to produce a homogeneous electrode sheet with a uniform thickness. Thus, an electrode sheet is produced by applying and drying the electrode composition 1000. In other words, an electrode sheet is a solidified product of the electrode composition 1000.

In the coating step S01 of the method for producing an electrode sheet, the active material 101 may be coated with the first solid electrolyte without the binder 103, and then in the kneading step S02, the coated active material 111 may be mixed with the binder 103. Such a production method can suppress the disposition of the binder 103 at the interface between the active material 101 and the first solid electrolyte and can improve the battery output characteristics. The coated active material 111 and the binder 103 are mixed, for example, by adding a styrene elastomer having a total nitrogen content of 30 ppm or more and 300 ppm or less to the coated active material.

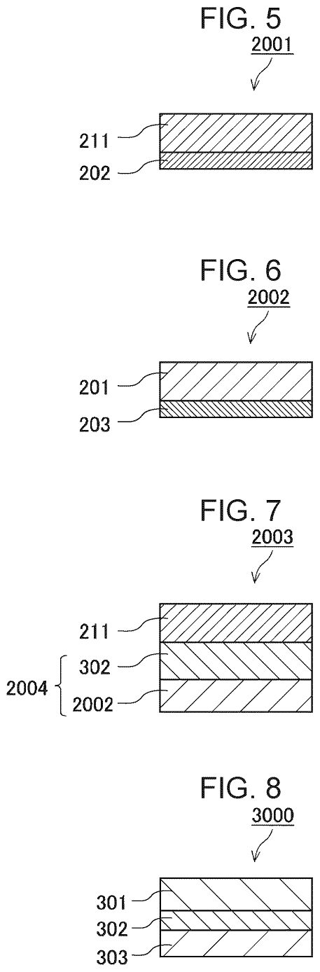

FIG. 5 is a cross-sectional view of an electrode transfer sheet 2001 according to the second embodiment. The electrode transfer sheet 2001 includes a substrate 202 and an electrode sheet 211 disposed on the substrate 202. The electrode transfer sheet 2001 can be produced by including a step of applying the electrode composition 1000 to the substrate 202 as the step S03.

FIG. 6 is a cross-sectional view of an electrode 2002 according to the second embodiment. The electrode 2002 includes a current collector 203 and an electrode sheet 201 disposed on the current collector 203. The electrode 2002 can be produced by including a step of applying the electrode composition 1000 to the current collector 203 as the step S03.

FIG. 7 is a cross-sectional view of a battery precursor 2003 according to the second embodiment. The battery precursor 2003 includes the electrode 2002, an electrolyte layer 302, and the electrode sheet 211. The electrolyte layer 302 is disposed on the electrode 2002. Furthermore, the electrode sheet 211 is disposed on the electrolyte layer 302. The electrode 2002 includes the current collector 203 and the electrode sheet 201 disposed on the current collector 203. An electrode assembly 2004 includes the electrode 2002 and a solid electrolyte layer 302 disposed on the electrode 2002.

In the step S03, the electrode composition 1000 is applied to the substrate 202, the current collector 203, or the electrode assembly 2004. Thus, a coating film of the electrode composition 1000 is formed on the substrate 202, the current collector 203, or the electrode assembly 2004.

The coating method may be a die coating method, a gravure coating method, a doctor blade method, a bar coating method, a spray coating method, an electrostatic coating method, or the like. From the perspective of mass productivity, the die coating method may be performed.

A material used for the substrate 202 may be metal foil or a resin film. A material of the metal foil may be copper (Cu), aluminum (Al), iron (Fe), nickel (Ni), an alloy thereof, or the like. A material of the resin film may be poly(ethylene terephthalate) (PET), polyimide (PI), polytetrafluoroethylene (PTFE), or the like. The electrode composition 1000 is applied to the substrate 202, and the step S04 described later is performed to produce the electrode transfer sheet 2001 composed of a laminate of the substrate 202 and the electrode sheet 211.

A material used for the current collector 203 may be metal foil. A material of the metal foil may be copper (Cu), aluminum (Al), iron (Fe), nickel (Ni), an alloy thereof, or the like. A coating layer composed of the above-described conductive additive and the above-described binder may be provided on the surface of the metal foil. The electrode composition 1000 is applied to the current collector 203, and the step S04 described later is performed to produce the electrode 2002 composed of a laminate of the current collector 203 and the electrode sheet 201.

The electrolyte layer 302 can be formed on the electrode 2002 to produce the electrode assembly 2004. In a method for forming the electrolyte layer 302, a solid electrolyte composition composed of a solid electrolyte, a binder, a solvent, and the like is applied to the electrode 2002 and is dried to form the electrolyte layer 302 on the electrode 2002. Alternatively, a solid electrolyte composition is applied to a substrate and is dried to produce a solid electrolyte sheet, and the solid electrolyte sheet is transferred to the electrode 2002 to form the electrolyte layer 302 on the electrode 2002. Thus, the electrode assembly 2004 composed of a laminate of the electrode 2002 and the electrolyte layer 302 is produced.

In the step S04, the applied electrode composition 1000 is dried. The electrode composition 1000 is dried, for example, to remove the solvent 104 from the coating film of the electrode composition 1000 and produce the electrode sheet 201.

The drying method for removing the solvent 104 from the electrode composition 1000 may be warm air/hot air drying, infrared heating drying, drying under reduced pressure, vacuum drying, high-frequency dielectric heating drying, high-frequency induction heating drying, or the like. These may be used alone or in combination.

The solvent 104 may be removed from the electrode composition 1000 by drying under reduced pressure. That is, the solvent 104 may be removed from the electrode composition 1000 in a pressure atmosphere lower than the atmospheric pressure. The pressure atmosphere lower than the atmospheric pressure may be, for example, −0.01 MPa or less in gauge pressure. The drying under reduced pressure may be performed at 50° C. or more and 250° C. or less.

The solvent 104 may be removed from the electrode composition 1000 by vacuum drying. That is, the solvent 104 may be removed from the electrode composition 1000 at a temperature lower than the boiling point of the solvent 104 and in an atmosphere equal to or lower than the equilibrium vapor pressure of the solvent 104.

The solvent 104 may be removed from the electrode composition 1000 by warm air/hot air drying from the perspective of production cost. The set temperature of the warm air or hot air may be 50° C. or more and 250° C. or less, or 80° C. or more and 150° C. or less.

In the step S04, the amount of the solvent 104 removed from the electrode composition 1000 can be adjusted by the above-described drying method and conditions.

The removal of the solvent 104 can be confirmed by, for example, Fourier transform infrared spectroscopy (FT-IR), X-ray photoelectron spectroscopy (XPS), gas chromatography (GC), or gas chromatography/mass spectrometry (GC/MS). The solvent 104 may not be completely removed provided that the electrode sheet 201 after drying has ionic conductivity. Part of the solvent 104 may remain in the electrode sheet 201.

The battery precursor 2003 may be produced, for example, by combining the electrode 2002 and the electrode sheet 211 having a polarity opposite to the polarity of the electrode 2002. That is, the active material in the electrode sheet 201 is different from the active material in the electrode sheet 211. More specifically, when the active material in the electrode sheet 201 is a positive-electrode active material, the active material in the electrode sheet 211 is a negative-electrode active material. When the active material in the electrode sheet 201 is a negative-electrode active material, the active material in the electrode sheet 211 is a positive-electrode active material.

In the second embodiment, the electrode composition 1000 may be the electrode composition 1001.

### Third Embodiment

A third embodiment will be described below. The description overlapping with the first and second embodiments will be omitted as appropriate.

FIG. 8 is a cross-sectional view of a battery 3000 according to the third embodiment.

The battery 3000 according to the third embodiment includes a positive electrode 301, a negative electrode 303, and the electrolyte layer 302.

The electrolyte layer 302 is disposed between the positive electrode 301 and the negative electrode 303.

The battery 3000 includes the positive electrode 301, the electrolyte layer 302, and the negative electrode 303 in this order.

Either the positive electrode 301 or the negative electrode 303 may include the electrode sheet 201 according to the second embodiment.

The battery 3000 may include a homogeneous electrode sheet 201 with a uniform thickness. The electrode sheet 201 being a homogeneous and having a uniform thickness means that the variation in the thickness of the electrode sheet 201 is small. The electrode sheet 201 having a small variation in thickness can have a thickness close to the design value at all positions in the plane. Even when the electrolyte layer 302 is made thinner, this can reduce the possibility of contact (short circuit) between the positive electrode 301 and the negative electrode 303 and improve the energy density of the battery 3000.

Furthermore, the electrode sheet 201 having good dispersibility of the active material and/or the solid electrolyte tends to have good electronic conduction and/or ionic conduction in the electrode. This can improve the output characteristics of the battery 3000.

In the battery 3000, at least one selected from the group consisting of the positive electrode 301 and the negative electrode 303 may be the electrode 2002. The battery 3000 may be produced, for example, by combining the electrode 2002 and an electrode having a polarity opposite to the polarity of the electrode 2002. This method is good from the perspective of reducing the number of components. When the electrode 2002 is a positive electrode, the electrode having a polarity opposite to the polarity of the electrode 2002 is a negative electrode. When the electrode 2002 is a negative electrode, the electrode having a polarity opposite to the polarity of the electrode 2002 is a positive electrode. The positive electrode or the negative electrode includes a current collector and an active material layer disposed on the current collector. A layer containing a solid electrolyte may be provided in the active material layer of the positive electrode or the active material layer of the negative electrode.

A method for producing the battery 3000 may be a transfer method or a coating method. The transfer method is a method for producing the battery 3000 using the electrode transfer sheet 2001. That is, the transfer method is a method for producing the battery 3000 by producing each member of the battery 3000 in a separate step and combining these members. The coating method is, for example, a method for producing the battery 3000 including a method for directly forming a positive electrode or a negative electrode on an electrode assembly by applying and drying an electrode composition on the electrode assembly having an electrolyte layer laminated on the positive electrode or the negative electrode.

An example of a method for producing the battery 3000 by the transfer method will be described below.

The method for producing the battery 3000 includes, for example, applying the electrode composition 1000 to a substrate to form a coating film, removing the solvent from the coating film to form the electrode sheet 211, and transferring the electrode sheet 211 to the electrode assembly 2004. The electrode sheet 211 is combined with the current collector 203 to produce a second electrode and thereby produce the battery 3000. Thus, the battery 3000 including a first electrode, the electrolyte layer, and the second electrode in this order is produced. The electrode assembly 2004 includes the electrode 2002 and the electrolyte layer 302. The electrode 2002 is, for example, the first electrode.

A method for producing the battery 3000 by a coating method will be described below.

The method for producing the battery 3000 includes, for example, applying the electrode composition 1000 to the current collector 203 to form a coating film and removing the solvent 104 from the coating film to form the first electrode. Furthermore, the method for producing the battery 3000 includes combining the first electrode, the second electrode, and the electrolyte layer 302 such that the electrolyte layer 302 is located between the first electrode and the second electrode. Thus, the battery 3000 including the first electrode, the electrolyte layer, and the second electrode in this order is produced. The second electrode is disposed on the electrolyte layer 302 to produce the battery 3000. A method for disposing the second electrode on the electrolyte layer 302 may be a method for applying the electrode composition 1000 to the electrolyte layer 302, a method for transferring the electrode sheet 211 to the electrolyte layer 302, a method for bonding the second electrode, or the like. When the first electrode is a positive electrode, the second electrode is a negative electrode. When the first electrode is a negative electrode, the second electrode is a positive electrode. Each of the first electrode and the second electrode includes, for example, a current collector and an active material layer disposed on the current collector. A layer containing a solid electrolyte may be provided in the active material layer of the first electrode or the active material layer of the second electrode.

The method for producing the battery 3000 includes, for example, applying the electrode composition 1000 to the electrode assembly 2004 to form a coating film and removing the solvent from the coating film to form the electrode sheet 211. The electrode sheet 201 is combined with the current collector 203 to produce the second electrode and thereby produce the battery 3000. Thus, the battery 3000 including the first electrode, the electrolyte layer, and the second electrode in this order is produced. The electrode assembly 2004 includes the electrode 2002 and the electrolyte layer 302. The electrode 2002 is, for example, the first electrode.

These coating methods are superior to a transfer method for transferring the electrode sheet 211 formed on the substrate 202 from the perspective of reducing the number of components. In other words, the above-described methods are superior in mass productivity to the transfer method.

The battery 3000 may be produced by preparing a laminate in which a positive electrode, an electrolyte layer, and a negative electrode are arranged in this order by the above-described method and performing press forming using a pressing machine at normal temperature or a high temperature. Press forming can improve the filling characteristics of the coated active material 111, or the coated active material 111 and the second solid electrolyte 105, and provide the battery 3000 having high output power.

The battery 3000 may also be produced by the following method. A negative electrode having an electrode sheet (a first negative electrode sheet) laminated on a current collector, a first electrolyte layer, and a first positive electrode are arranged in this order.

On the other hand, an electrode sheet (a second negative electrode sheet), a second electrolyte layer, and a second positive electrode are arranged in this order on a surface opposite the surface of the current collector on which the first negative electrode sheet is laminated. A laminate thus produced includes the first positive electrode, the first electrolyte layer, the first negative electrode sheet, the current collector, the second negative electrode sheet, the second electrolyte layer, and the second positive electrode arranged in this order. The laminate may be press-formed using a pressing machine at normal temperature or a high temperature to produce the battery 3000. Such a method can produce a stack of two batteries 3000 while suppressing warping of the batteries and more efficiently produce high-output batteries 3000. In the production of the stack, the order of laminating each member is not particularly limited. For example, a stack of two batteries 3000 may be produced by disposing a first negative electrode sheet and a second electrode sheet on a current collector and then laminating a first electrolyte layer, a second electrolyte layer, a first positive electrode, and a second positive electrode in this order.

In the second embodiment, the electrode composition 1000 may be the electrode composition 1001.

The electrolyte layer 302 is a layer containing an electrolyte material. The electrolyte material is, for example, a solid electrolyte. Thus, the electrolyte layer 302 may be a solid electrolyte layer. The solid electrolyte in the electrolyte layer 302 may be one of the materials exemplified as the solid electrolyte in the first embodiment. The solid electrolyte may be, for example, a sulfide solid electrolyte, an oxide solid electrolyte, a halide solid electrolyte, a polymeric solid electrolyte, a complex hydride solid electrolyte, or the like.

The electrolyte layer 302 may contain a solid electrolyte as a main component. The electrolyte layer 302 may contain a solid electrolyte at a mass ratio of 70% or more (70% by mass or more) relative to the entire electrolyte layer 302.

Such a configuration can further improve the output characteristics of the battery 3000.

The electrolyte layer 302 may contain a solid electrolyte as a main component and further contain incidental impurities. The incidental impurities may be starting materials used to synthesize the solid electrolyte, by-products, decomposition products, and the like. The electrolyte layer 302 may contain a solid electrolyte at a mass ratio of 100% relative to the entire electrolyte layer 302, except for incidental impurities.

Such a configuration can further improve the output characteristics of the battery 3000.

The electrolyte layer 302 may contain a solid electrolyte as a main component and further contain incidental impurities. The incidental impurities may be starting materials used to synthesize the solid electrolyte, by-products, decomposition products, and the like.

The electrolyte layer 302 may contain a solid electrolyte at a mass ratio of 100% relative to the entire electrolyte layer 302, except for incidental impurities.

Such a configuration can further improve the output characteristics of the battery 3000.

The electrolyte layer 302 may contain two or more of the materials described as the solid electrolyte. For example, the electrolyte layer 302 may contain a halide solid electrolyte and a sulfide solid electrolyte.

The electrolyte layer 302 may have a thickness of 1 μm or more and 300 μm or less. The electrolyte layer 302 with a thickness of 1 μm or more reduces the possibility of a short circuit between the positive electrode 301 and the negative electrode 303. The electrolyte layer 302 with a thickness of 300 μm or less allows the battery 3000 to operate easily at high output power. That is, when the thickness of the electrolyte layer 302 is appropriately adjusted, the safety of the battery 3000 can be sufficiently ensured, and the battery 3000 can operate at high output power.

The solid electrolyte sheet in the electrolyte layer 302 may have a thickness of 1 μm or more and 30 μm or less, 1 μm or more and 15 μm or less, or 1 μm or more and 7.5 μm or less. The solid electrolyte sheet with a thickness of 1 μm or more reduces the possibility of a short circuit between the positive electrode 301 and the negative electrode 303. The solid electrolyte sheet with a thickness of 30 μm or less can reduce the internal resistance of the battery 3000, allows the battery 3000 to operate at high output power, and improve the energy density of the battery 3000. The thickness of a solid electrolyte sheet is defined by, for example, an average value of a plurality of arbitrary points (for example, three points) in a cross section parallel to the thickness direction.

The shape of the solid electrolyte in the battery 3000 is not particularly limited. The shape of the solid electrolyte may be needle-like, spherical, ellipsoidal, or the like. The shape of the solid electrolyte may be particulate.

At least one selected from the group consisting of the positive electrode 301 and the negative electrode 303 may contain an electrolyte material and may contain, for example, a solid electrolyte. The solid electrolyte may be a solid electrolyte exemplified as a material constituting the electrolyte layer 302. Such a configuration can improve the ionic conductivity (for example, lithium ion conductivity) in the positive electrode 301 or the negative electrode 303 and allows the battery 3000 to operate at high output power.

In the positive electrode 301 or the negative electrode 303, a sulfide solid electrolyte may be used as a solid electrolyte, and the above-described halide solid electrolyte may be used as a coating material for coating an active material, or a halide solid electrolyte may be used as a solid electrolyte, and the above-described sulfide solid electrolyte may be used as a coating material for coating an active material.

The positive electrode 301 contains, for example, a material having a property of storing and releasing metal ions (for example, lithium ions) as a positive-electrode active material. The positive-electrode active material may be one of the materials exemplified in the first embodiment.

When the shape of the solid electrolyte in the positive electrode 301 is particulate (for example, spherical), the solid electrolyte may have a median diameter of 100 μm or less. When the solid electrolyte has a median diameter of 100 μm or less, the positive-electrode active material and the solid electrolyte can be well dispersed in the positive electrode 301. This improves the charge-discharge characteristics of the battery 3000.

The median diameter of the solid electrolyte in the positive electrode 301 may be smaller than the median diameter of the positive-electrode active material. In such a case, the solid electrolyte and the positive-electrode active material can be well dispersed.

The positive-electrode active material may have a median diameter of 0.1 μm or more and 100 μm or less. When the positive-electrode active material has a median diameter of 0.1 μm or more, the positive-electrode active material and the solid electrolyte can be well dispersed in the positive electrode 301. This improves the charge-discharge characteristics of the battery 3000. When the positive-electrode active material has a median diameter of 100 μm or less, the lithium diffusion rate in the positive-electrode active material is improved. This allows the battery 3000 to operate at high output power.

In the positive electrode 301, the volume ratio “v₁:100−v₁” of the positive-electrode active material and the solid electrolyte may satisfy 30≤v₁≤95. v₁ denotes the volume ratio of the positive-electrode active material when the total volume of the positive-electrode active material and the solid electrolyte in the positive electrode 301 is 100. By satisfying 30≤v₁, a sufficient energy density of the battery 3000 can be easily ensured. By satisfying v₁≤95, the battery 3000 can more easily operate at high output power.

The positive electrode 301 may have a thickness of 10 μm or more and 500 μm or less. When the positive electrode 301 has a thickness of 10 μm or more, the battery 3000 can easily have a sufficient energy density. When the positive electrode 301 has a thickness of 500 μm or less, the battery 3000 can more easily operate at high output power.

When the positive electrode 301 includes the electrode sheet 201, the electrode sheet 201 may have a thickness of 10 μm or more and 500 μm or less, or 20 μm or more and 200 μm or less. The electrode sheet 201 with a thickness of 10 μm or more can improve the energy density of the battery 3000. The electrode sheet 201 with a thickness of 500 μm or less can reduce the internal resistance of the battery 3000, allowing the battery 3000 to operate at high output power. The thickness of the electrode sheet 201 is defined by, for example, an average value of a plurality of arbitrary points (for example, three points) in a cross section parallel to the thickness direction.

The negative electrode 303 contains, for example, a material having a property of storing and releasing metal ions (for example, lithium ions) as a negative-electrode active material. The negative-electrode active material may be one of the materials exemplified in the first embodiment.

The negative-electrode active material may have a median diameter of 0.1 μm or more and 100 μm or less. When the negative-electrode active material has a median diameter of 0.1 μm or more, the negative-electrode active material and the solid electrolyte can be well dispersed in the negative electrode 303. This improves the charge-discharge characteristics of the battery 3000. When the negative-electrode active material has a median diameter of 100 μm or less, the lithium diffusion rate in the negative-electrode active material is improved. This allows the battery 3000 to operate at high output power.

The median diameter of the negative-electrode active material may be larger than the median diameter of the solid electrolyte. Thus, the solid electrolyte and the negative-electrode active material can be well dispersed.

The volume ratio “v₂:100−v₂” of the negative-electrode active material and the solid electrolyte in the negative electrode 303 may satisfy 30≤v₂≤95. v₂ denotes the volume ratio of the negative-electrode active material when the total volume of the negative-electrode active material and the solid electrolyte in the negative electrode 303 is 100. By satisfying 30≤v₂, a sufficient energy density of the battery 3000 can be easily ensured. By satisfying v₂≤95, the battery 3000 can more easily operate at high output power.

The negative electrode 303 may have a thickness of 10 μm or more and 500 μm or less. When the negative electrode 303 has a thickness of 10 μm or more, the battery 3000 can easily have a sufficient energy density. When the negative electrode 303 has a thickness of 500 μm or less, the battery 3000 can more easily operate at high output power.

When the negative electrode 303 includes the electrode sheet 201, the electrode sheet 201 may have a thickness of 10 μm or more and 500 μm or less, or 20 μm or more and 200 μm or less. The electrode sheet 201 with a thickness of 10 μm or more can improve the energy density of the battery 3000. The electrode sheet 201 with a thickness of 500 μm or less can reduce the internal resistance of the battery 3000 and allows the battery 3000 to operate at high output power. The thickness of the electrode sheet 201 is defined by, for example, an average value of a plurality of arbitrary points (for example, three points) in a cross section parallel to the thickness direction.

The positive-electrode active material and the negative-electrode active material may be coated with a coating material to reduce the interface resistance between each active material and the solid electrolyte. The coating material may be a material having low electronic conductivity. The coating material may be an oxide material, an oxide solid electrolyte, a halide solid electrolyte, a sulfide solid electrolyte, or the like exemplified in the first embodiment.

At least one selected from the group consisting of the positive electrode 301, the electrolyte layer 302, and the negative electrode 303 may contain a binder for the purpose of improving the adhesion between particles. The binder may be one of the materials exemplified in the first embodiment. When the binder contains an elastomer, each layer of the positive electrode 301, the electrolyte layer 302, and the negative electrode 303 in the battery 3000 tends to have high flexibility and elasticity. This tends to improve the durability of the battery 3000.

At least one selected from the group consisting of the positive electrode 301, the electrolyte layer 302, and the negative electrode 303 may contain a nonaqueous electrolyte solution, a gel electrolyte, or an ionic liquid for the purpose of facilitating the transmission and reception of lithium ions and improving the output characteristics of the battery 3000.

The nonaqueous electrolyte solution contains a nonaqueous solvent and a lithium salt dissolved in the nonaqueous solvent. The nonaqueous solvent may be a cyclic carbonate solvent, a chain carbonate solvent, a cyclic ether solvent, a chain ether solvent, a cyclic ester solvent, a chain ester solvent, a fluorinated solvent, or the like. The cyclic carbonate solvent may be ethylene carbonate, propylene carbonate, butylene carbonate, or the like. The chain carbonate solvent may be dimethyl carbonate, ethyl methyl carbonate, diethyl carbonate, or the like. The cyclic ether solvent may be tetrahydrofuran, 1,4-dioxane, 1,3-dioxolane, or the like. The chain ether solvent may be 1,2-dimethoxyethane, 1,2-diethoxyethane, or the like. The cyclic ester solvent may be γ-butyrolactone or the like. The chain ester solvent may be methyl acetate or the like. The fluorinated solvent may be fluoroethylene carbonate, methyl fluoropropionate, fluorobenzene, fluoroethyl methyl carbonate, fluorodimethylene carbonate, or the like. The nonaqueous solvent may be one nonaqueous solvent selected from these alone or a mixture of two or more nonaqueous solvents selected from these.

The nonaqueous electrolyte solution may contain at least one fluorinated solvent selected from the group consisting of fluoroethylene carbonate, methyl fluoropropionate, fluorobenzene, fluoroethyl methyl carbonate, and fluorodimethylene carbonate.

The lithium salt may be LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), LiC(SO₂CF₃)₃, or the like. The lithium salt may be one lithium salt selected from these alone or a mixture of two or more lithium salts selected from these. The concentration of the lithium salt in the nonaqueous electrolyte solution may be 0.5 mol/l or more and 2 mol/l or less.

The gel electrolyte may be a material in which a nonaqueous electrolyte solution is contained in a polymer material. The polymer material may be poly(ethylene oxide), polyacrylonitrile, poly(vinylidene difluoride), poly(methyl methacrylate), polymer having an ethylene oxide bond, or the like.

A cation constituting the ionic liquid may be an aliphatic chain quaternary cation, such as tetraalkylammonium or tetraalkylphosphonium, an alicyclic ammonium, such as pyrrolidinium, morpholinium, imidazolinium, tetrahydropyrimidinium, piperazinium, or piperidinium, a nitrogen-containing heteroaromatic cation, such as pyridinium or imidazolium, or the like. An anion constituting the ionic liquid may be PF₆⁻, BF₄⁻, SbF₆⁻, AsF₆⁻, SO₃CF₃⁻, N(SO₂F)₂⁻, N(SO₂CF₃)₂⁻, N(SO₂C₂F₅)₂⁻, N(SO₂CF₃)(SO₂C₄F₉), C(SO₂CF₃)₃⁻, or the like. The ionic liquid may contain a lithium salt.

At least one selected from the group consisting of the positive electrode 301 and the negative electrode 303 may contain a conductive additive for the purpose of improving electronic conductivity. The conductive additive may be one of the materials exemplified in the first embodiment.

The battery 3000 may be a liquid battery containing an electrolyte solution. In this case, the electrolyte layer 302 may be a porous film made of a resin, such as a polyolefin. Each of the positive electrode 301, the electrolyte layer 302, and the negative electrode 303 may be impregnated with a nonaqueous electrolyte solution.

The shape of the battery 3000 may be a coin shape, a cylindrical shape, a square or rectangular shape, a sheet shape, a button shape, a flat shape, a laminate shape, or the like.

### OTHER EMBODIMENTS

### Supplementary Notes

The description of the above embodiments discloses the following techniques.

### (Technique 1)

An electrode composition containing:
a solvent;
a coated active material dispersed in the solvent; and
a binder dispersed in the solvent,
wherein the coated active material includes an active material and a coating layer covering at least part of a surface of the active material,
the coating layer contains a first solid electrolyte,
the first solid electrolyte contains at least one selected from the group consisting of a sulfide solid electrolyte and a halide solid electrolyte,
the binder contains a styrene elastomer, and
the styrene elastomer has a total nitrogen content of 30 ppm or more and 300 ppm or less.

According to the present disclosure, an appropriate interaction acts between the coated active material and the binder in the electrode composition. This interaction can improve the flowability of the electrode composition.

### (Technique 2)

The electrode composition according to Technique 1, wherein
the first solid electrolyte includes the halide solid electrolyte,
the halide solid electrolyte contains Li, M, and X,
the Mis at least one selected from the group consisting of a metal element and a metalloid element other than Li, and
the X is at least one selected from the group consisting of F, Cl, Br, and I.

In such a configuration, since the halide solid electrolyte does not contain sulfur, generation of hydrogen sulfide gas can be suppressed.

### (Technique 3)

The electrode composition according to Technique 2, wherein the Mis at least one selected from the group consisting of Ca, Mg, Al, Y, Ti, and Zr. In such a configuration, since the halide solid electrolyte has a higher ionic conductivity, the battery can have higher output power.

### (Technique 4)

The electrode composition according to Technique 3, wherein the Mis at least one selected from the group consisting of Al, Y, and Ti. In such a configuration, since the halide solid electrolyte has a higher ionic conductivity, the battery can have higher output power.

### (Technique 5)

The electrode composition according to Technique 5, wherein the X includes F. In such a configuration, the halide solid electrolyte has high electrochemical stability and can therefore improve the cycle characteristics of the battery.

### (Technique 6)

The electrode composition according to Technique 1, wherein the first solid electrolyte is represented by the following composition formula (1):

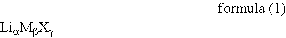

the Mis at least one selected from the group consisting of a metal element and a metalloid element other than Li, and
the X is at least one selected from the group consisting of F, Cl, Br, and I, and α, β, and γ each independently denotes a value greater than 0.

In such a configuration, since the halide solid electrolyte has a high ionic conductivity, the battery can have higher output power.

### (Technique 7)

The electrode composition according to Technique 1, wherein the first solid electrolyte includes the sulfide solid electrolyte. In such a configuration, since the sulfide solid electrolyte has a high ionic conductivity, the battery can have higher output power.

### (Technique 8)

The electrode composition according to Technique 7, wherein the sulfide solid electrolyte contains a Li₂S—P₂S₅ glass ceramic. In such a configuration, since Li₂S—P₂S₅ glass ceramic is a relatively soft material having high ionic conductivity, the battery can have still higher output power.

### (Technique 9)

The electrode composition according to Technique 1, wherein the binder contains at least one selected from the group consisting of modified SEBS and modified SBR. In such a configuration, the modified SEBS or the modified SBR has higher flexibility and elasticity and is therefore particularly suitable as a binder for an electrode sheet.

### (Technique 10)

The electrode composition according to Technique 1, wherein the solvent has a boiling point of 100° C. or more and 250° C. or less. In such a configuration, since the solvent is less likely to volatilize at normal temperature, the electrode composition can be stably produced.

### (Technique 11)

The electrode composition according to Technique 1, wherein the solvent contains an aromatic hydrocarbon. In such a configuration, the binder tends to have high solubility in the aromatic hydrocarbon. In particular, the styrene elastomer is easily dissolved in the aromatic hydrocarbon. When the binder has high solubility in the aromatic hydrocarbon, the dispersibility of the coated active material in the electrode composition can be further improved. Furthermore, since the aromatic hydrocarbon has a relatively low polarity, it is possible to suppress a decrease in ionic conductivity due to excessive adsorption and/or reaction with a solid electrolyte.

### (Technique 12)

The electrode composition according to Technique 1, wherein the solvent contains tetralin. In such a configuration, since tetralin has a relatively high boiling point, it is possible not only to improve the flowability of the electrode composition but also to stably produce the electrode composition by a kneading process.

### (Technique 13)

The electrode composition according to Technique 1, wherein the coating layer is composed of a plurality of layers. Such a configuration can improve both the cycle characteristics and the output characteristics in a battery including an electrode sheet produced from the electrode composition.

### (Technique 14)

The electrode composition according to Technique 1, further containing a second solid electrolyte. Such a configuration can improve the ionic conductivity of an electrode sheet produced from the electrode composition, and the battery can have higher output power.

### (Technique 15)

The electrode composition according to any one of Techniques 1 to 14, wherein the coating layer has an outermost layer composed of a layer containing the first solid electrolyte. In such a configuration, the flowability of the electrode composition can be further improved by providing the first solid electrolyte in the outermost layer, which is highly likely to come into contact with the binder.

### (Technique 16)

A method for producing an electrode composition, the method including:
coating an active material with a first solid electrolyte without using a binder to form a coated active material; and
mixing a solvent, the coated active material, and a binder,
wherein the coated active material includes an active material and a coating layer covering at least part of a surface of the active material,
the coating layer contains a first solid electrolyte,
the first solid electrolyte contains at least one selected from the group consisting of a sulfide solid electrolyte and a halide solid electrolyte,
the binder contains a styrene elastomer, and
the styrene elastomer has a total nitrogen content of 30 ppm or more and 300 ppm or less.

With such a configuration, a battery having higher output characteristics can be produced. This can also suppress the disposition of the binder at the interface between the active material and the first solid electrolyte and further improve the output characteristics of the battery.

### (Technique 17)

A method for producing an electrode composition, the method including:
coating an active material with a first solid electrolyte without using a binder to form a coated active material; and
mixing the coated active material with a styrene elastomer having a total nitrogen content of 30 ppm or more and 300 ppm or less, in this order.

Such a configuration can suppress the disposition of the binder at the interface between the active material and the first solid electrolyte and improve the output characteristics of the battery.

### (Technique 18)

A method for producing an electrode sheet, the method including:
applying the electrode composition according to Technique 1 to a substrate, a current collector, or an electrode assembly to form a coating film; and
removing the solvent from the coating film.

With such a configuration, a homogeneous electrode sheet with a uniform thickness can be produced.

### (Technique 19)

A method for producing a battery including a first electrode, an electrolyte layer, and a second electrode in this order, the method including the following (i), (ii), or (iii):
(i) applying the electrode composition according to Technique 1 to a substrate to form a coating film,
removing the solvent from the coating film to form an electrode sheet for the second electrode, and
combining the first electrode, the second electrode, and the electrolyte layer such that the electrolyte layer is located between the first electrode and the second electrode,
(ii) applying the electrode composition according to Technique 1 to a current collector to form a coating film,
removing the solvent from the coating film to form the first electrode, and
combining the first electrode, the second electrode, and the electrolyte layer such that the electrolyte layer is located between the first electrode and the second electrode,
(iii) applying the electrode composition according to Technique 1 to the electrolyte layer of an electrode assembly that is a laminate of the first electrode and the electrolyte layer, thereby forming a coating film, and
removing the solvent from the coating film to form an electrode sheet for the second electrode.

With such a configuration, a battery having a higher energy density can be produced.

### EXAMPLES

The present disclosure will be described in detail below with reference to examples and comparative examples. An electrode composition, an electrode sheet, and a battery according to the present disclosure are not limited to the following examples.

### Example 1-1

### [Solvent]

In all the following steps, a commercially available dehydrated solvent or a solvent dehydrated by nitrogen bubbling was used as a solvent. The water content of the solvent was 10 ppm by mass or less.

### [Preparation of Binder Solution]

A binder solution was prepared by adding a solvent to a binder and dissolving or dispersing the binder in the solvent. The concentration of the binder in the binder solution was adjusted to 5% by mass or more and 10% by mass or less. A dehydration treatment was then performed by nitrogen bubbling until the water content of the binder solution reached 10 ppm by mass or less.

In Example 1-1, tetralin was used as the solvent of the binder solution. A styrene elastomer constituting the binder was a solution-polymerized styrene-butadiene rubber (modified SBR). The modified SBR was Asaprene (registered trademark) Y031 manufactured by Asahi Kasei Corporation. In the styrene elastomer constituting the binder, the mole fraction of the repeating unit derived from styrene was 0.16, and the weight-average molecular weight (Mw) of the binder was 380,000.

### [Preparation of First Solid Electrolyte]

In an argon glove box at a dew point of −60° C. or less, raw material powders LiF, TiF₄, and AlF₃ were weighed at a mole ratio of LiF:TiF₄:AlF3=2.7:0.3:0.7. These were ground and mixed in a mortar to prepare a mixture. The mixture was milled in a planetary ball mill at 500 rpm for 12 hours. A bead mill treatment was then performed. Thus, a powder of a halide solid electrolyte was prepared as a first solid electrolyte of Example 1. The halide solid electrolyte of Example 1 had a composition represented by Li_{2.7}Ti_{0.3}Al_{0.7}F₆ (hereinafter referred to as “LTAF”).

### [Preparation of Coated Active Material]

A powder of Li(NiCoAl)O₂ (hereinafter referred to as “NCA”) was prepared as a positive-electrode active material. A coating layer composed of LTAF was formed on the surface of NCA. The coating layer was formed by a shear treatment using a particle mixing apparatus (BALANCE GRAN, manufactured by Freund-Turbo Corporation). More specifically, NCA and LTAF were weighed at a mass ratio of 97.31:2.69 and were treated under the conditions of a rotational speed of 1000 rpm and a treatment time of 135 minutes. At this time, no binder was added. Thus, a coated active material of Example 1 was prepared.

### [Production of Electrode Composition]

Tetralin and a binder solution were added to the coated active material in an argon glove box at a dew point of −60° C. or less. These materials were mixed at a mass ratio of coated active material:binder=100:1.17, and the solid concentration (NV) was adjusted to 82. The resulting liquid mixture was then kneaded in a planetary mixer (ARE-310 manufactured by Thinky Corporation) under the conditions of 1600 rpm and 3 minutes to produce an electrode composition of Example 1.

### Example 2

An electrode composition of Example 2 was produced in the same manner as in Example 1 except that a mixture containing a hydrogenated styrene thermoplastic elastomer (modified SEBS, manufactured by Asahi Kasei Corporation, Tuftec (registered trademark) MP10) and a hydrogenated block copolymer (SEBS, manufactured by Kraton Corporation, G1633) at a mass ratio of 2:3 was used as the styrene elastomer constituting the binder. In the styrene elastomer constituting the binder used in Example 2, the mole fraction of the repeating unit derived from styrene was 0.19, and the weight-average molecular weight (Mw) of the binder was 270,000.

### Example 3

An electrode composition of Example 3 was produced in the same manner as in Example 1 except that a mixture containing the hydrogenated styrene thermoplastic elastomer (modified SEBS, manufactured by Asahi Kasei Corporation, Tuftec MP10) and the hydrogenated block copolymer (SEBS, manufactured by Kraton Corporation, G1633) at a mass ratio of 1:1 was used as the styrene elastomer constituting the binder. In the styrene elastomer constituting the binder used in Example 3, the mole fraction of the repeating unit derived from styrene was 0.19, and the weight-average molecular weight (Mw) of the binder was 240,000.

### Comparative Example 1

An electrode composition of Comparative Example 1 was produced in the same manner as in Example 1 except that a solution-polymerized styrene-butadiene rubber (SBR, manufactured by Asahi Kasei Corporation, Tufdene 2100R) was used as the styrene elastomer constituting the binder. In the styrene elastomer constituting the binder used in Comparative Example 1, the mole fraction of the repeating unit derived from styrene was 0.16, and the weight-average molecular weight (Mw) of the binder was 390,000.

### Comparative Example 2

An electrode composition of Comparative Example 2 was produced in the same manner as in Example 1 except that a mixture containing the hydrogenated styrene thermoplastic elastomer (modified SEBS, manufactured by Asahi Kasei Corporation, Tuftec MP10) and the hydrogenated block copolymer (SEBS, manufactured by Kraton Corporation, G1633) at a mass ratio of 7:3 was used as the styrene elastomer constituting the binder. In the styrene elastomer constituting the binder used in Comparative Example 2, the mole fraction of the repeating unit derived from styrene was 0.20, and the weight-average molecular weight (Mw) of the binder was 170,000.

### Comparative Example 3

An electrode composition of Comparative Example 3 was produced in the same manner as in Example 1 except that a mixture containing the hydrogenated styrene thermoplastic elastomer (modified SEBS, manufactured by Asahi Kasei Corporation, Tuftec MP10) and the hydrogenated block copolymer (SEBS, manufactured by Kraton Corporation, G1633) at a mass ratio of 4:1 was used as the styrene elastomer constituting the binder. In the styrene elastomer constituting the binder used in Comparative Example 3, the mole fraction of the repeating unit derived from styrene was 0.20, and the weight-average molecular weight (Mw) of the binder was 140,000.

### Comparative Example 4

An electrode composition of Comparative Example 4 was produced in the same manner as in Example 1 except that the hydrogenated styrene thermoplastic elastomer (modified SEBS, manufactured by Asahi Kasei Corporation, Tuftec MP10) was used as the styrene elastomer constituting the binder. In the styrene elastomer constituting the binder used in Comparative Example 4, the mole fraction of the repeating unit derived from styrene was 0.20, and the weight-average molecular weight (Mw) of the binder was 58,000.

### Comparative Example 5

An electrode composition of Comparative Example 5 was produced in the same manner as in Example 1 except that no binder was used.

### Comparative Example 6

An electrode composition of Comparative Example 6 was produced in the same manner as in Example 1 except that the coating layer was not formed on the positive-electrode active material.

### [Measurement of Total Nitrogen Content of Styrene Elastomer]

The total nitrogen content of the styrene elastomer constituting the binder was measured by trace total nitrogen measurement using a total nitrogen microanalyzer (TN-2100H manufactured by Nittoseiko Analytech Co., Ltd.). The measurement conditions were as described below.

### [Measurement Conditions]

Temperature of pyrolysis furnace: 800° C.
Temperature of oxidation furnace: 900° C.
Carrier gas: O₂ and Ar
Standard sample: pyridine/toluene solution
Detector: reduced-pressure chemiluminescence detector

Under these measurement conditions, the mass (μg) of nitrogen (N) contained in 1 g of a polymer was measured to calculate the total nitrogen content from the ratio (μg/g=ppm).

### <Evaluation of Electrode Composition>

The rheology of the electrode compositions of Examples 1 to 3 and Comparative Examples 1 to 6 was evaluated by the following method and conditions.

### [Evaluation of Flowability]

The flowability of the electrode composition was evaluated in a dry room at a dew point of −40° C. or less. For the measurement, a viscosity/viscoelasticity measuring instrument (HAAKE MARS40 manufactured by Thermo Fisher Scientific Inc.) and a cone-plate with a diameter of 35 mm and an angle of 2 degrees (C35/2 Ti manufactured by Thermo Fisher Scientific Inc.) were used. The viscosity of the electrode composition was measured at a shear rate in the range of 0.1/s to 1000/s under the conditions of 25° C. and a speed control mode (CR mode), and a flow curve was created by plotting the shear rate on the horizontal axis and plotting the viscosity on the vertical axis. The behavior of the electrode composition was then evaluated according to the above-described criteria in the created flow curve. In Table 1, a circle (O) indicates high flowability. A cross mark (X) indicates poor flowability.

### [Calculation of Viscosity Ratio]

The viscosity of the electrode composition was measured in a dry room at a dew point of −40° C. or less. For the measurement, a viscosity/viscoelasticity measuring instrument (HAAKE MARS40 manufactured by Thermo Fisher Scientific Inc.) and a cone-plate with a diameter of 35 mm and an angle of 2 degrees (C35/2 Ti manufactured by Thermo Fisher Scientific Inc.) were used. The viscosity of the electrode composition was measured at a shear rate in the range of 0.1/s to 1000/s under the conditions of 25° C. and the speed control mode (CR mode) to calculate the viscosity ratio η₁/η₂ by the above-described method.

### [Measurement of Casson Yield Value]

The rheology of the electrode composition was measured in a dry room at a dew point of −40° C. or less. For the measurement, a viscosity/viscoelasticity measuring instrument (HAAKE MARS40 manufactured by Thermo Fisher Scientific Inc.) and a cone-plate with a diameter of 35 mm and an angle of 2 degrees (C35/2 Ti manufactured by Thermo Fisher Scientific Inc.) were used. The shear stress of the electrode composition was measured at a shear rate in the range of 0.1/s to 1000/s under the conditions of 25° C. and the speed control mode (CR) to determine the Casson yield value by the above-described method.

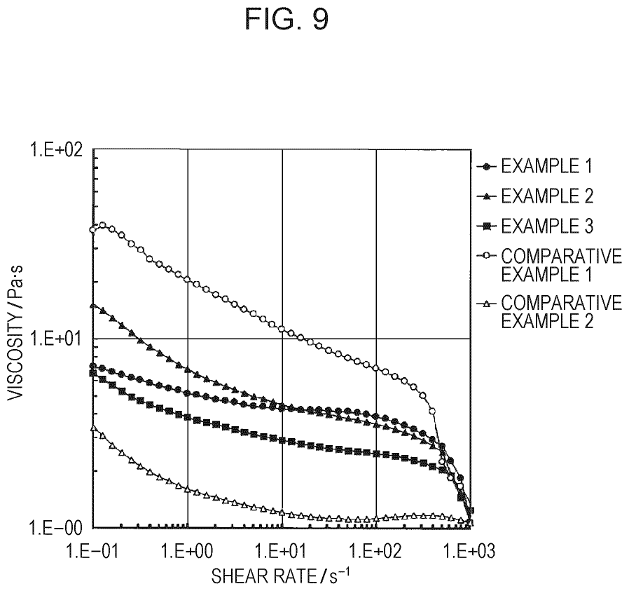

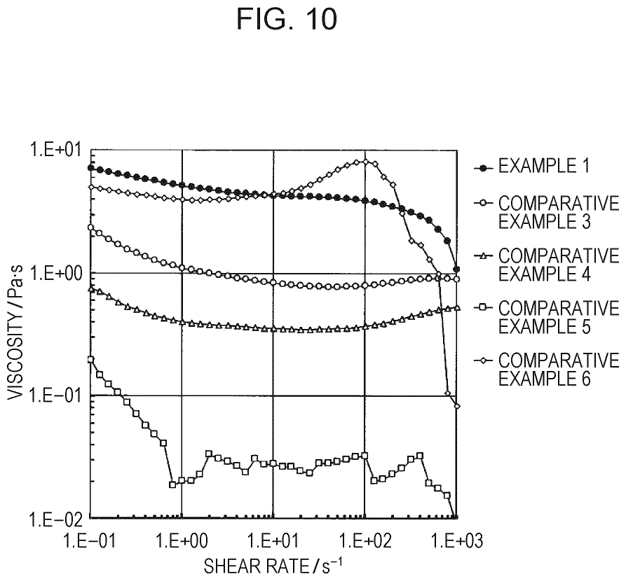

The results of the measurements are shown in Table 1 and FIGS. 9 and 10.

Types A to G of the binder in Table 1 correspond to the following polymers.
A: solution-polymerized styrene-butadiene rubber (modified SBR), Asaprene Y031
B: 2:3 mixture of hydrogenated styrene thermoplastic elastomer (amine-modified SEBS) Tuftec MP10 and hydrogenated block copolymer (SEBS) G1633
C: 1:1 mixture of hydrogenated styrene thermoplastic elastomer (amine-modified SEBS) Tuftec MP10 and hydrogenated block copolymer (SEBS) G1633
D: solution-polymerized styrene-butadiene rubber (SBR), Tufdene 2100R E: 7:3 mixture of hydrogenated styrene thermoplastic elastomer (amine-modified SEBS) Tuftec MP10 and hydrogenated block copolymer (SEBS) G1633
F: 4:1 mixture of hydrogenated styrene thermoplastic elastomer (amine-modified SEBS) Tuftec MP10 and hydrogenated block copolymer (SEBS) G1633
G: hydrogenated styrene thermoplastic elastomer (amine-modified SEBS) Tuftec MP10

It is presumed that the solution-polymerized styrene-butadiene rubber of type A contains a nitrogen component by substituting an end of the polymer with a nitrogen-containing group. It is presumed that the solution-polymerized styrene-butadiene rubber of type D contains a nitrogen component due to impurities other than the polymer that is the main component.

FIGS. 9 and 10 are graphs obtained by plotting the viscosity obtained in the evaluation of the flowability of the electrode composition versus the shear rate in the examples and the comparative examples. FIG. 9 shows the results of Examples 1 to 3 and Comparative Examples 1 and 2. FIG. 10 shows the results of Example 1 and Comparative Examples 3 to 6. In the electrode compositions of Examples 1 to 3 and Comparative Examples 1 to 6, the flowability was evaluated as “high (O)” or “poor (X)” according to which of A to D in the graph of FIG. 2 the graph obtained by plotting the viscosity versus shear rate was similar to.

TABLE 1

| | | Binder in electrode | | Rheology of electrode composition | | |
|---|---|---|---|---|---|---|
| | First solid | composition | | | Viscosity | Casson |
| | electrolyte of | Type of | Total nitrogen | | ratio | yield value |
| | coating layer | binder | content (ppm) | Flowability | (η₁/η₂) | (Pa) |
| Example 1 | LTAF | A | 110 | ∘ | 1.3 | 0.30 |
| Example 2 | LTAF | B | 210 | ∘ | 1.9 | 1.1 |
| Example 3 | LTAF | C | 250 | ∘ | 1.5 | 0.31 |
| Comparative | LTAF | D | 4.4 | x | 2.9 | 8.0 |
| example 1 | | | | | | |
| Comparative | LTAF | E | 340 | x | 1.4 | 0.029 |
| example 2 | | | | | | |
| Comparative | LTAF | F | 380 | x | 1.4 | 0.0083 |
| example 3 | | | | | | |
| Comparative | LTAF | G | 470 | x | 1.1 | 0.0038 |
| example 4 | | | | | | |
| Comparative | LTAF | None | None | x | 0.62 | 0.00089 |
| example 5 | | | | | | |
| Comparative | None | A | 110 | x | 0.49 | 1.0 |
| example 6 | | | | | | |

The electrode compositions of Examples 1 to 3 and Comparative Examples 1 to 4 all contain the coated active material and the styrene elastomer as a binder. As can be seen from Table 1 and FIGS. 9 and 10, the electrode compositions of Examples 1 to 3 had high flowability. In Comparative Example 1, the total nitrogen content of the styrene elastomer in the electrode composition was low. Thus, in Comparative Example 1, it is presumed that the adsorption of the binder to the coated active material was insufficient and the flowability of the electrode composition was poor. In Comparative Examples 2 to 4, the total nitrogen content of the styrene elastomer was high. Thus, in Comparative Examples 2 to 4, it is presumed that the adsorption of the binder to the coated active material was excessive and the flowability of the electrode composition was poor. In Comparative Example 5, it is presumed that since the styrene elastomer was not used, the flowability of the electrode composition was poor. In Comparative Example 6, it is presumed that since the coating layer was not provided on the positive-electrode active material, the flowability of the electrode composition was poor.

As can be seen from Table 1, the electrode compositions of the examples in which the active material was provided with the coating layer of the first solid electrolyte and the styrene elastomer with a nitrogen content of 30 ppm or more and 300 ppm or less was used as the binder could have improved flowability.

An electrode composition, an electrode sheet, and a battery according to the present disclosure can be used, for example, for production of a lithium-ion secondary battery.

What is claimed is:

1. An electrode composition comprising:
a solvent;
a coated active material dispersed in the solvent; and
a binder dispersed in the solvent,
wherein the coated active material includes an active material and a coating layer covering at least part of a surface of the active material,
the coating layer contains a first solid electrolyte,
the first solid electrolyte contains at least one selected from the group consisting of a sulfide solid electrolyte and a halide solid electrolyte,
the binder contains a styrene elastomer, and
the styrene elastomer has a total nitrogen content of 30 ppm or more and 300 ppm or less.

2. The electrode composition according to claim 1, wherein
the first solid electrolyte includes the halide solid electrolyte,
the halide solid electrolyte contains Li, M, and X,
the Mis at least one selected from the group consisting of a metal element and a metalloid element other than Li, and
the X is at least one selected from the group consisting of F, Cl, Br, and I.

3. The electrode composition according to claim 2, wherein the Mis at least one selected from the group consisting of Ca, Mg, Al, Y, Ti, and Zr.

4. The electrode composition according to claim 3, wherein the Mis at least one selected from the group consisting of Al, Y, and Ti.

5. The electrode composition according to claim 4, wherein the X includes F.

6. The electrode composition according to claim 1, wherein the first solid electrolyte is represented by the following composition formula (1): 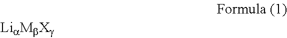
wherein the Mis at least one selected from the group consisting of a metal element and a metalloid element other than Li,
the X is at least one selected from the group consisting of F, Cl, Br, and I, and
α, β, and γ each independently denotes a value greater than 0.

7. The electrode composition according to claim 1, wherein the first solid electrolyte includes the sulfide solid electrolyte.

8. The electrode composition according to claim 7, wherein the sulfide solid electrolyte contains a Li₂S—P₂S₅ glass ceramic.

9. The electrode composition according to claim 1, wherein the binder contains at least one selected from the group consisting of modified SEBS and modified SBR.

10. The electrode composition according to claim 1, wherein the solvent has a boiling point of 100° C. or more and 250° C. or less.

11. The electrode composition according to claim 1, wherein the solvent contains an aromatic hydrocarbon.

12. The electrode composition according to claim 7, wherein the solvent contains tetralin.

13. The electrode composition according to claim 1, wherein the coating layer is composed of a plurality of layers.

14. The electrode composition according to claim 1, further comprising a second solid electrolyte.

15. The electrode composition according to claim 1, wherein the coating layer has an outermost layer composed of a layer containing the first solid electrolyte.

16. A method for producing an electrode composition, the method comprising:
coating an active material with a first solid electrolyte without using a binder to form a coated active material; and
mixing a solvent, the coated active material, and a binder,
wherein the coated active material includes an active material and a coating layer covering at least part of a surface of the active material,
the coating layer contains a first solid electrolyte,
the first solid electrolyte contains at least one selected from the group consisting of a sulfide solid electrolyte and a halide solid electrolyte,
the binder contains a styrene elastomer, and
the styrene elastomer has a total nitrogen content of 30 ppm or more and 300 ppm or less.

17. A method for producing an electrode composition, the method comprising:
coating an active material with a first solid electrolyte without using a binder to form a coated active material, and
mixing the coated active material with a styrene elastomer having a total nitrogen content of 30 ppm or more and 300 ppm or less, in this order.

18. A method for producing an electrode sheet, the method comprising:
applying the electrode composition according to claim 1 to a substrate, a current collector, or an electrode assembly to form a coating film; and
removing the solvent from the coating film.

19. A method for producing a battery including a first electrode, an electrolyte layer, and a second electrode in this order, the method comprising the following (i), (ii), or (iii):
(i) applying the electrode composition according to claim 1 to a substrate to form a coating film,
removing the solvent from the coating film to form an electrode sheet for the second electrode, and
combining the first electrode, the second electrode, and the electrolyte layer such that the electrolyte layer is located between the first electrode and the second electrode,
(ii) applying the electrode composition according to claim 1 to a current collector to form a coating film,
removing the solvent from the coating film to form the first electrode, and
combining the first electrode, the second electrode, and the electrolyte layer such that the electrolyte layer is located between the first electrode and the second electrode,
(iii) applying the electrode composition according to claim 1 to the electrolyte layer of an electrode assembly that is a laminate of the first electrode and the electrolyte layer, thereby forming a coating film, and
removing the solvent from the coating film to form an electrode sheet for the second electrode.
